(19) United States
(12) Patent Application Publication
(10) Pub. No.: US 2017/0300936 A1
(43) Pub. Date: Oct. 19, 2017

(54) SYSTEMS AND METHODS FOR ASSESSING PURCHASE OPPORTUNITIES

(71) Applicant: Wal-Mart Stores, Inc., Bentonville, AR (US)

(72) Inventors: Bruce W. Wilkinson, Rogers, AR (US); Brian G. McHale, Chadderton Oldham (GB); Todd D. Mattingly, Bentonville, AR (US)

(21) Appl. No.: 15/487,826

(22) Filed: Apr. 14, 2017

Related U.S. Application Data
(60) Provisional application No. 62/323,026, filed on Apr. 15, 2016.
(60) Provisional application No. 62/348,444, filed on Jun. 10, 2016.
(60) Provisional application No. 62/436,842, filed on Dec. 20, 2016.
(60) Provisional application No. 62/485,045, filed on Apr. 13, 2017.
(60) Provisional application No. 62/397,455, filed on Sep. 21, 2016.
(60) Provisional application No. 62/402,164, filed on Sep. 30, 2016.
(60) Provisional application No. 62/402,195, filed on Sep. 30, 2016.
(60) Provisional application No. 62/402,651, filed on Sep. 30, 2016.
(60) Provisional application No. 62/402,692, filed on Sep. 30, 2016.
(60) Provisional application No. 62/467,968, filed on Mar. 7, 2017.

(51) Int. Cl. G06Q 30/02

(52) U.S. Cl. CPC G06Q 30/0201

(57) ABSTRACT

In some embodiments, systems and methods are provided herein useful to assess purchase opportunities corresponding to the sale of retail products. In some embodiments, systems are provided to assess purchase opportunities corresponding to the sale of retail products and may include a communication transceiver communicatively coupled to a control circuit. By one approach, the database may include a plurality of partiality vectors (“PV”) each associated with a commercial object or a consumer. The control circuit selects a purchase opportunity that identifies a consumer and commercial objects. The control circuit determines a first and second alignment value that define a relationship between the consumer and a commercial object or a replacement commercial object. The control circuit can replace the commercial object with the replacement commercial object when the second alignment value is higher than the first alignment value by at least a threshold value.

### RELATED APPLICATIONS

This application claims the benefit of each of the following U.S. Provisional applications, each of which is incorporated herein by reference in its entirety: 62/323,026 filed Apr. 15, 2016 (Attorney Docket No. 8842-137893-USPR_1235US01); 62/348,444 filed Jun. 10, 2016 (Attorney Docket No. 8842-138849-USPR_3677US01); 62/436,842 filed Dec. 20, 2016 (Attorney Docket No. 8842-140072-USPR_3678US01); 62/485,045, filed Apr. 13, 2017 (Attorney Docket No. 8842-140820-USPR_4211US01); 62/397,455, filed Sep. 21, 2016 (Attorney Docket No. 8842-138679-USPR_1256US01); 62/402,164, filed Sep. 30, 2016 (Attorney Docket No. 8842-139001-USPR_1943US01); 62/402,195, filed Sep. 30, 2016 (Attorney Docket No. 8842-139450-USPR_2870US01); 62/402,651, filed Sep. 30, 2016 (Attorney Docket No. 8842-139451-USPR_2871US01); 62/402,692, filed Sep. 30, 2016 (Attorney Docket No. 8842-139452-USPR_2872US01); and 62/467,968, filed Mar. 7, 2017 (Attorney Docket No. 8842-138827-USPR_1594US01).

### TECHNICAL FIELD

These teachings relate generally to providing products and services to individuals and in some cases, relates to assessing purchase opportunities.

### BACKGROUND

Various shopping paradigms are known in the art. One approach of long-standing use essentially comprises displaying a variety of different goods at a shared physical location and allowing consumers to view/experience those offerings as they wish to thereby make their purchasing selections. This model is being increasingly challenged due at least in part to the logistical and temporal inefficiencies that accompany this approach and also because this approach does not assure that a product best suited to a particular consumer will in fact be available for that consumer to purchase at the time of their visit.

Increasing efforts are being made to present a given consumer with one or more purchasing options that are selected based upon some preference of the consumer. When done properly, this approach can help to avoid presenting the consumer with things that they might not wish to consider. That said, existing preference-based approaches nevertheless leave much to be desired. Information regarding preferences, for example, may tend to be very product specific and accordingly may have little value apart from use with a very specific product or product category. As a result, while helpful, a preferences-based approach is inherently very limited in scope and offers only a very weak platform by which to assess a wide variety of product and service categories.

One particular technical challenge to improve upon the foregoing is the sheer computational complexity of making a more nuanced assessment of what products and services a particular customer might fancy, given the right opportunity and presentation. The sheer number of products (certainly numbering in the millions) and the sheer number of potential customers (numbering now in the billions) makes legitimate consideration of even a single point of preference for a given customer an enormously taxing activity. That computational complexity, in turn, requires either a great deal of time to process (and hence risks missing a window of opportunity) and/or a great deal of computational capability (and hence can greatly increase a given retailer's overhead and therefore the price to the consumer).

Many retailers and advertisers send unsolicited sales offers and advertising material to customers. Oftentimes, the retailers and advertisers have very limited information about the people to whom they are sending the offers and materials. Consequently, these retailers and advertisers apply a brute force method of sending offers and material in that they send the offers and materials to every person, household, business, etc. without any knowledge as to whether the people receiving the offers and materials will be interested in the products and services presented in the offers and materials. While sending offers and materials in such a manner may generate some interest, frequently the vast majority of the offers and materials sent are disregarded. Consequently, this brute force method is inefficient and not cost effective.

### BRIEF DESCRIPTION OF THE DRAWINGS

The above needs are at least partially met through provision of the vector-based characterizations of products described in the following detailed description, particularly when studied in conjunction with the drawings. Disclosed herein are embodiments of systems and methods pertaining to assessing purchase opportunities corresponding to the sale of commercial objects. This description includes drawings, wherein:

FIG. 1 comprises a flow diagram as configured in accordance with various embodiments of these teachings;

FIG. 2 comprises a flow diagram as configured in accordance with various embodiments of these teachings;

FIG. 3 comprises a graphic representation as configured in accordance with various embodiments of these teachings;

FIG. 4 comprises a graph as configured in accordance with various embodiments of these teachings;

FIG. 5 comprises a flow diagram as configured in accordance with various embodiments of these teachings;

FIG. 6 comprises a graphic representation as configured in accordance with various embodiments of these teachings;

FIG. 7 comprises a graphic representation as configured in accordance with various embodiments of these teachings;

FIG. 8 comprises a graphic representation as configured in accordance with various embodiments of these teachings;

FIG. 9 comprises a flow diagram as configured in accordance with various embodiments of these teachings;

FIG. 10 comprises a flow diagram as configured in accordance with various embodiments of these teachings;

FIG. 11 comprises a graphic representation as configured in accordance with various embodiments of these teachings;

FIG. 12 comprises a graphic representation as configured in accordance with various embodiments of these teachings;

FIG. 13 comprises a block diagram as configured in accordance with various embodiments of these teachings;

FIG. 14 comprises a flow diagram as configured in accordance with various embodiments of these teachings;

FIG. 15 comprises a graph as configured in accordance with various embodiments of these teachings;

FIG. 16 comprises a flow diagram as configured in accordance with various embodiments of these teachings;

FIG. 17 comprises a block diagram as configured in accordance with various embodiments of these teachings;

FIG. 18 illustrates a simplified block diagram of a system to assess purchase opportunities corresponding to the sale of commercial objects, in accordance with some embodiments;

FIG. 19 is a flowchart of an exemplary process of assessing purchase opportunities corresponding to the sale of commercial objects, in accordance with several embodiments;

FIG. 20 illustrates an exemplary system for use in implementing methods, techniques, devices, apparatuses, systems, servers, sources and assessing purchase opportunities corresponding to the sale of commercial objects, in accordance with some embodiments;

FIG. 21 comprises a flow diagram as configured in accordance with various embodiments of these teachings;

FIG. 22 comprises a block diagram as configured in accordance with various embodiments of these teachings;

FIG. 23 comprises a flow diagram as configured in accordance with various embodiments of these teachings;

FIG. 24 comprises a flow diagram as configured in accordance with various embodiments of these teachings;

FIG. 25 comprises a flow diagram as configured in accordance with various embodiments of these teachings;

FIG. 26 is a diagram depicting example operations for determining potential customers for a customizable product, according to some embodiments;

FIG. 27 is a block diagram depicting an example potential customer determination system for determining potential customers for a customizable product, according to some embodiments; and

FIG. 28 is a flow chart depicting example operations for determining potential customers for a customizable product, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems and methods are provided herein useful to assess purchase opportunities corresponding to the sale of retail products. In some embodiments, systems are provided to assess purchase opportunities corresponding to the sale of commercial objects. The system may also include a database and a communication transceiver each communicatively coupled to the control circuit. The database having a plurality of partiality vectors each associated with either a commercial object or a consumer. The control circuit generally accesses a purchase opportunity that includes information regarding both a consumer identifier that is exclusively associated with a consumer and one or more commercial object identifiers each exclusively associated with a commercial object. The consumer identifier is typically associated with one or more consumer partiality vectors (“first PVs”). Each commercial object identifier can be associated with one or more commercial object partiality vectors (“second PVs”).

For one or more of the commercial object identifiers disclosed in the purchase opportunity, the control circuit can determine a first alignment value and a second alignment value. By one approach, the first alignment value corresponds to an alignment relationship between the one or more first PVs and the one or more second PVs. Typically, the second alignment corresponds to an alignment relationship between the one or more first PVs and the one or more partiality vector for a replacement commercial object (“third PVs”), which shares a threshold amount of characteristics with the commercial object. The control circuit can identify an opportunity to increase the probability of the consumer participating in the purchase opportunity when the second alignment value is greater than the first determined alignment value by at least a threshold value. The control circuit can replace the commercial object identifier with the replacement commercial object identifier when the opportunity is identified. When each commercial object identifier identified by the purchase opportunity is assessed, the control circuit can cause the communications transceiver to transmit the purchase opportunity to an electronic user device associated with the consumer to thereby be rendered through a consumer user interface implemented on the electronic user device.

In some embodiments, methods are provided for assessing purchase opportunities corresponding to the sale of retail products. Some of these methods include accessing a purchase opportunity having both a consumer identifier that is exclusively associated with a consumer and one or more commercial object identifiers each exclusively associated with a particular commercial object. The consumer identifier is typically associated with one or more first PVs. Each commercial object identifier can be associated one or more second PVs. For each commercial object identifier of the purchase opportunity, the method may include identifying a first alignment value and a second alignment value. By one approach, the first alignment value can correspond to an alignment relationship between the one or more first PVs and the one or more second PVs. The second alignment value can correspond to a relationship between the one or more first PVs and one or more partiality vectors of a replacement commercial object (“third PV”).

In light of the identified alignment values, the method may also identify an opportunity to increase the probability of the consumer participating in the purchase opportunity when the second alignment value is greater than the first determined alignment value by at least a threshold value. The method can replace the commercial object identifier with the replacement commercial object identifier when the opportunity is identified. When each commercial object identifier identified by the purchase opportunity is assessed, the method further may cause transmission of the purchase opportunity to an electronic user device associated with the consumer for rendering through a consumer user interface implemented on the electronic user device.

Generally speaking, many of these embodiments provide for a memory having information stored therein that includes partiality information for each of a plurality of persons in the form of a plurality of partiality vectors for each of the persons wherein each partiality vector has at least one of a magnitude and an angle that corresponds to a magnitude of the person's belief in an amount of good that comes from an order associated with that partiality. This memory can also contain vectorized characterizations for each of a plurality of products, wherein each of the vectorized characterizations includes a measure regarding an extent to which a corresponding one of the products accords with a corresponding one of the plurality of partiality vectors.

Rules can then be provided that use the aforementioned information in support of a wide variety of activities and results. Although the described vector-based approaches bear little resemblance (if any) (conceptually or in practice) to prior approaches to understanding and/or metricizing a given person's product/service requirements, these approaches yield numerous benefits including, at least in some cases, reduced memory requirements, an ability to accommodate (both initially and dynamically over time) an essentially endless number and variety of partialities and/or product attributes, and processing/comparison capabilities that greatly ease computational resource requirements and/or greatly reduced time-to-solution results.

In some embodiments, pursuant to these teachings a control circuit has access to information including a plurality of partiality vectors for a customer and vectorized characterizations for each of a plurality of products. The control circuit is configured as a state engine that uses the foregoing information to identify at least one product to present to that customer. By one approach, for example, the state engine uses a first state to process that information to identify a product to at least maintain or to reduce the customer's effort and a second, different state to process that information to identify at least one product to assist the customer with realizing an aspiration.

By one approach these teachings accommodate the state engine having a customer baseline experience state and transitioning from that state upon detecting disorder with respect to the customer's baseline experience. By one approach a disorder disambiguation state serves to determine when a detected disorder comprises a disruption occasion by the customer when reordering their life towards realizing an aspiration and when such is not the case.

So configured, these teachings can help minimize the technical requirements for the computational resources required to identify (within some reasonable time frame) genuinely useful and productive suggestions of products and services that a particular customer may appreciate. In addition, the disclosed approach can be particularly helpful when dealing with deviations from a person's routine that may be caused by any of a plurality of different causes.

In further embodiments, pursuant to these teachings, a control circuit has access to information including a plurality of partiality vectors for a customer and vectorized product characterizations for each of a plurality of products and uses this information to select a product to present to a customer. When this results in a plurality of equally suitable products, the control circuit selects whichever of the products offers a highest degree of freedom of usage.

By one approach, each degree of freedom of usage corresponds to a different modality of usage. Information regarding these degrees of freedom of usage may be previously developed and stored pending usage by the control circuit or may, if desired, be determined by the control circuit on an as-needed basis.

By one approach, the control circuit is further configured to present a selected product to a customer in conjunction with information that explains the degree of freedom of usage that corresponds to the presented product.

These teachings will also accommodate supplementing the foregoing approaches by selecting a product, at least in part, as a function of objective information regarding the customer and/or objective logistical information regarding providing particular products to the customer.

In further embodiments, pursuant to these teachings a control circuit has access to a memory that stores a plurality of partiality vectors for a customer as well as vectorized characterizations for each of a plurality of products. The control circuit uses the foregoing to identify at least one product to present to the customer by, at least in part, using the partiality vectors and the vectorized characterizations to define a plurality of solutions that collectively form a multi-dimensional surface (formed, for example, in N-dimensional space). The control circuit then selects the at least one product from that multi-dimensional surface.

By one approach, the control circuit also accesses other information for the customer (such as but not limited to objective information regarding the customer) and uses that other information to constrain a selection area on the multi-dimensional surface from which the at least one product can be selected. These teachings are highly flexible in these regards and will accommodate a variety of different types of such other information. Examples include location information, budget information, age information, and gender information.

So configured, these teachings can help minimize the technical requirements for the computational resources required to identify (within some reasonable time frame) genuinely useful and productive suggestions of products and services that a particular customer may appreciate.

And in further embodiments, pursuant to these teachings, a control circuit has access to information including a plurality of partiality vectors for a customer and vectorized product characterizations for each of a plurality of products. Upon identifying an aspiration of the customer, the control circuit uses the aforementioned information to identify at least one product to assist the customer with realizing the aspiration.

By one approach the control circuit has access to information regarding a routine experiential base state for the customer, which information the control circuit employs to detect a disruption to that experiential base state. In this case the control circuit can be further configured to identify whether an aspiration is the cause of the disruption and, if so, which aspiration. By one approach the control circuit identifies a particular customer source aspiration by disambiguating amongst a plurality of candidate aspirations that are consistent with the aforementioned disruption.

By one approach, the control circuit also accesses and uses expert inputs when identifying a product to assist the customer with realizing the aspiration.

By yet another approach, the control circuit is configured to identify a plurality of incremental steps that correspond to realizing the customer aspiration and to determine the customer's present state of accomplishment as regards those steps. In this case the partiality vectors and vectorized product characterizations can be used to identify a product to assist the customer with accomplishing a selected one of those incremental steps.

And by yet another approach, the control circuit is configured to determine an extent of the customer's aspiration. In this case the control circuit can be configured to identify at least one product that is consistent with that determined extent of the customer's aspiration.

People tend to be partial to ordering various aspects of their lives, which is to say, people are partial to having things well arranged per their own personal view of how things should be. As a result, anything that contributes to the proper ordering of things regarding which a person has partialities represents value to that person. Quite literally, improving order reduces entropy for the corresponding person (i.e., a reduction in the measure of disorder present in that particular aspect of that person's life) and that improvement in order/reduction in disorder is typically viewed with favor by the affected person.

Generally speaking a value proposition must be coherent (logically sound) and have “force.” Here, force takes the form of an imperative. When the parties to the imperative have a reputation of being trustworthy and the value proposition is perceived to yield a good outcome, then the imperative becomes anchored in the center of a belief that “this is something that I must do because the results will be good for me.” With the imperative so anchored, the corresponding material space can be viewed as conforming to the order specified in the proposition that will result in the good outcome.

Pursuant to these teachings a belief in the good that comes from imposing a certain order takes the form of a value proposition. It is a set of coherent logical propositions by a trusted source that, when taken together, coalesce to form an imperative that a person has a personal obligation to order their lives because it will return a good outcome which improves their quality of life. This imperative is a value force that exerts the physical force (effort) to impose the desired order. The inertial effects come from the strength of the belief. The strength of the belief comes from the force of the value argument (proposition). And the force of the value proposition is a function of the perceived good and trust in the source that convinced the person's belief system to order material space accordingly. A belief remains constant until acted upon by a new force of a trusted value argument. This is at least a significant reason why the routine in people's lives remains relatively constant.

Newton's three laws of motion have a very strong bearing on the present teachings. Stated summarily, Newton's first law holds that an object either remains at rest or continues to move at a constant velocity unless acted upon by a force, the second law holds that the vector sum of the forces F on an object equal the mass m of that object multiplied by the acceleration a of the object (i.e., F=ma), and the third law holds that when one body exerts a force on a second body, the second body simultaneously exerts a force equal in magnitude and opposite in direction on the first body.

Relevant to both the present teachings and Newton's first law, beliefs can be viewed as having inertia. In particular, once a person believes that a particular order is good, they tend to persist in maintaining that belief and resist moving away from that belief. The stronger that belief the more force an argument and/or fact will need to move that person away from that belief to a new belief.

Relevant to both the present teachings and Newton's second law, the “force” of a coherent argument can be viewed as equaling the “mass” which is the perceived Newtonian effort to impose the order that achieves the aforementioned belief in the good which an imposed order brings multiplied by the change in the belief of the good which comes from the imposition of that order. Consider that when a change in the value of a particular order is observed then there must have been a compelling value claim influencing that change. There is a proportionality in that the greater the change the stronger the value argument. If a person values a particular activity and is very diligent to do that activity even when facing great opposition, we say they are dedicated, passionate, and so forth. If they stop doing the activity, it begs the question, what made them stop? The answer to that question needs to carry enough force to account for the change.

And relevant to both the present teachings and Newton's third law, for every effort to impose good order there is an equal and opposite good reaction.

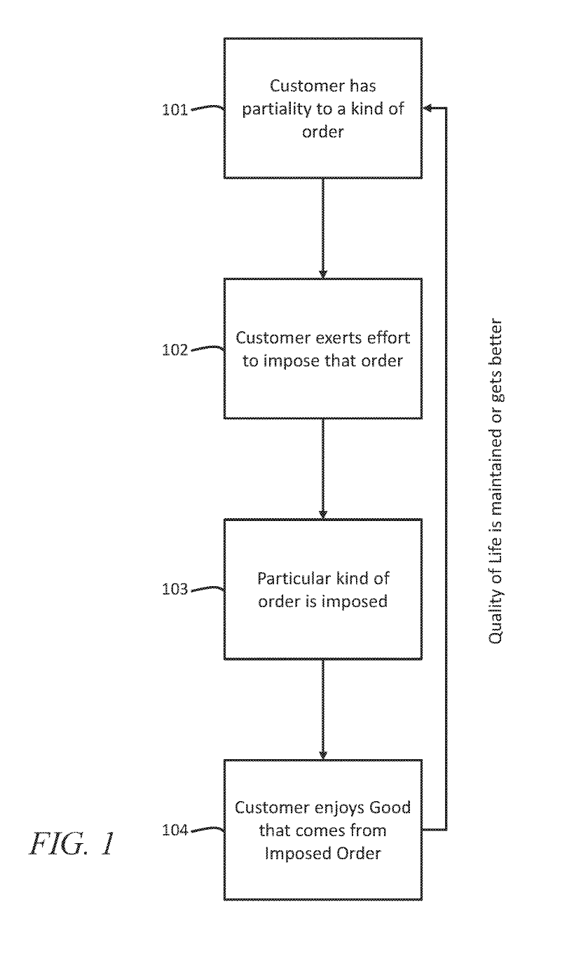

FIG. 1 provides a simple illustrative example in these regards. At block 101 it is understood that a particular person has a partiality (to a greater or lesser extent) to a particular kind of order. At block 102 that person willingly exerts effort to impose that order to thereby, at block 103, achieve an arrangement to which they are partial. And at block 104, this person appreciates the “good” that comes from successfully imposing the order to which they are partial, in effect establishing a positive feedback loop.

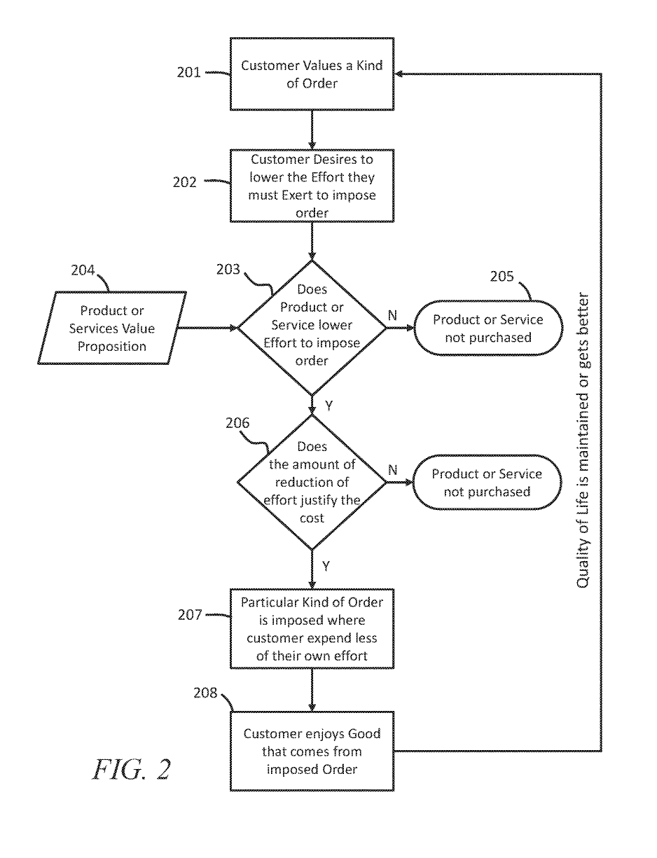

Understanding these partialities to particular kinds of order can be helpful to understanding how receptive a particular person may be to purchasing a given product or service. FIG. 2 provides a simple illustrative example in these regards. At block 201 it is understood that a particular person values a particular kind of order. At block 202 it is understood (or at least presumed) that this person wishes to lower the effort (or is at least receptive to lowering the effort) that they must personally exert to impose that order. At decision block 203 (and with access to information 204 regarding relevant products and or services) a determination can be made whether a particular product or service lowers the effort required by this person to impose the desired order. When such is not the case, it can be concluded that the person will not likely purchase such a product/service 205 (presuming better choices are available).

When the product or service does lower the effort required to impose the desired order, however, at block 206 a determination can be made as to whether the amount of the reduction of effort justifies the cost of purchasing and/or using the proffered product/service. If the cost does not justify the reduction of effort, it can again be concluded that the person will not likely purchase such a product/service 205. When the reduction of effort does justify the cost, however, this person may be presumed to want to purchase the product/service and thereby achieve the desired order (or at least an improvement with respect to that order) with less expenditure of their own personal effort (block 207) and thereby achieve, at block 208, corresponding enjoyment or appreciation of that result.

To facilitate such an analysis, the applicant has determined that factors pertaining to a person's partialities can be quantified and otherwise represented as corresponding vectors (where “vector” will be understood to refer to a geometric object/quantity having both an angle and a length/magnitude). These teachings will accommodate a variety of differing bases for such partialities including, for example, a person's values, affinities, aspirations, and preferences.

A value is a person's principle or standard of behavior, their judgment of what is important in life. A person's values represent their ethics, moral code, or morals and not a mere unprincipled liking or disliking of something. A person's value might be a belief in kind treatment of animals, a belief in cleanliness, a belief in the importance of personal care, and so forth.

An affinity is an attraction (or even a feeling of kinship) to a particular thing or activity. Examples including such a feeling towards a participatory sport such as golf or a spectator sport (including perhaps especially a particular team such as a particular professional or college football team), a hobby (such as quilting, model railroading, and so forth), one or more components of popular culture (such as a particular movie or television series, a genre of music or a particular musical performance group, or a given celebrity, for example), and so forth.

“Aspirations” refer to longer-range goals that require months or even years to reasonably achieve. As used herein “aspirations” does not include mere short term goals (such as making a particular meal tonight or driving to the store and back without a vehicular incident). The aspired-to goals, in turn, are goals pertaining to a marked elevation in one's core competencies (such as an aspiration to master a particular game such as chess, to achieve a particular articulated and recognized level of martial arts proficiency, or to attain a particular articulated and recognized level of cooking proficiency), professional status (such as an aspiration to receive a particular advanced education degree, to pass a professional examination such as a state Bar examination of a Certified Public Accountants examination, or to become Board certified in a particular area of medical practice), or life experience milestone (such as an aspiration to climb Mount Everest, to visit every state capital, or to attend a game at every major league baseball park in the United States). It will further be understood that the goal(s) of an aspiration is not something that can likely merely simply happen of its own accord; achieving an aspiration requires an intelligent effort to order one's life in a way that increases the likelihood of actually achieving the corresponding goal or goals to which that person aspires. One aspires to one day run their own business as versus, for example, merely hoping to one day win the state lottery.

A preference is a greater liking for one alternative over another or others. A person can prefer, for example, that their steak is cooked “medium” rather than other alternatives such as “rare” or “well done” or a person can prefer to play golf in the morning rather than in the afternoon or evening. Preferences can and do come into play when a given person makes purchasing decisions at a retail shopping facility. Preferences in these regards can take the form of a preference for a particular brand over other available brands or a preference for economy-sized packaging as versus, say, individual serving-sized packaging.

Values, affinities, aspirations, and preferences are not necessarily wholly unrelated. It is possible for a person's values, affinities, or aspirations to influence or even dictate their preferences in specific regards. For example, a person's moral code that values non-exploitive treatment of animals may lead them to prefer foods that include no animal-based ingredients and hence to prefer fruits and vegetables over beef and chicken offerings. As another example, a person's affinity for a particular musical group may lead them to prefer clothing that directly or indirectly references or otherwise represents their affinity for that group. As yet another example, a person's aspirations to become a Certified Public Accountant may lead them to prefer business-related media content.

While a value, affinity, or aspiration may give rise to or otherwise influence one or more corresponding preferences, however, is not to say that these things are all one and the same; they are not. For example, a preference may represent either a principled or an unprincipled liking for one thing over another, while a value is the principle itself. Accordingly, as used herein it will be understood that a partiality can include, in context, any one or more of a value-based, affinity-based, aspiration-based, and/or preference-based partiality unless one or more such features is specifically excluded per the needs of a given application setting.

Information regarding a given person's partialities can be acquired using any one or more of a variety of information-gathering and/or analytical approaches. By one simple approach, a person may voluntarily disclose information regarding their partialities (for example, in response to an online questionnaire or survey or as part of their social media presence). By another approach, the purchasing history for a given person can be analyzed to intuit the partialities that led to at least some of those purchases. By yet another approach demographic information regarding a particular person can serve as yet another source that sheds light on their partialities. Other ways that people reveal how they order their lives include but are not limited to: (1) their social networking profiles and behaviors (such as the things they “like” via Facebook, the images they post via Pinterest, informal and formal comments they initiate or otherwise provide in response to third-party postings including statements regarding their own personal long-term goals, the persons/topics they follow via Twitter, the photographs they publish via Picasso, and so forth); (2) their Internet surfing history; (3) their on-line or otherwise-published affinity-based memberships; (4) real-time (or delayed) information (such as steps walked, calories burned, geographic location, activities experienced, and so forth) from any of a variety of personal sensors (such as smart phones, tablet/pad-styled computers, fitness wearables, Global Positioning System devices, and so forth) and the so-called Internet of Things (such as smart refrigerators and pantries, entertainment and information platforms, exercise and sporting equipment, and so forth); (5) instructions, selections, and other inputs (including inputs that occur within augmented-reality user environments) made by a person via any of a variety of interactive interfaces (such as keyboards and cursor control devices, voice recognition, gesture-based controls, and eye tracking-based controls), and so forth.

The present teachings employ a vector-based approach to facilitate characterizing, representing, understanding, and leveraging such partialities to thereby identify products (and/or services) that will, for a particular corresponding consumer, provide for an improved or at least a favorable corresponding ordering for that consumer. Vectors are directed quantities that each have both a magnitude and a direction. Per the applicant's approach these vectors have a real, as versus a metaphorical, meaning in the sense of Newtonian physics. Generally speaking, each vector represents order imposed upon material space-time by a particular partiality.

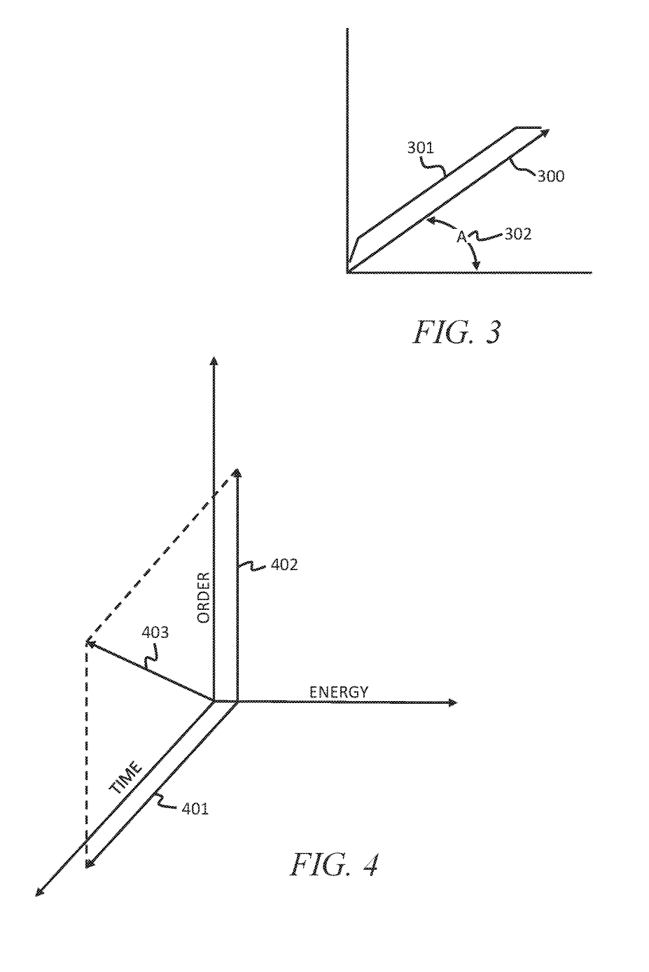

FIG. 3 provides some illustrative examples in these regards. By one approach the vector 300 has a corresponding magnitude 301 (i.e., length) that represents the magnitude of the strength of the belief in the good that comes from that imposed order (which belief, in turn, can be a function, relatively speaking, of the extent to which the order for this particular partiality is enabled and/or achieved). In this case, the greater the magnitude 301, the greater the strength of that belief and vice versa. Per another example, the vector 300 has a corresponding angle A 302 that instead represents the foregoing magnitude of the strength of the belief (and where, for example, an angle of 0° represents no such belief and an angle of 90° represents a highest magnitude in these regards, with other ranges being possible as desired).

Accordingly, a vector serving as a partiality vector can have at least one of a magnitude and an angle that corresponds to a magnitude of a particular person's belief in an amount of good that comes from an order associated with a particular partiality.

Applying force to displace an object with mass in the direction of a certain partiality-based order creates worth for a person who has that partiality. The resultant work (i.e., that force multiplied by the distance the object moves) can be viewed as a worth vector having a magnitude equal to the accomplished work and having a direction that represents the corresponding imposed order. If the resultant displacement results in more order of the kind that the person is partial to then the net result is a notion of “good.” This “good” is a real quantity that exists in meta-physical space much like work is a real quantity in material space. The link between the “good” in meta-physical space and the work in material space is that it takes work to impose order that has value.

In the context of a person, this effort can represent, quite literally, the effort that the person is willing to exert to be compliant with (or to otherwise serve) this particular partiality. For example, a person who values animal rights would have a large magnitude worth vector for this value if they exerted considerable physical effort towards this cause by, for example, volunteering at animal shelters or by attending protests of animal cruelty.

While these teachings will readily employ a direct measurement of effort such as work done or time spent, these teachings will also accommodate using an indirect measurement of effort such as expense; in particular, money. In many cases people trade their direct labor for payment. The labor may be manual or intellectual. While salaries and payments can vary significantly from one person to another, a same sense of effort applies at least in a relative sense.

As a very specific example in these regards, there are wristwatches that require a skilled craftsman over a year to make. The actual aggregated amount of force applied to displace the small components that comprise the wristwatch would be relatively very small. That said, the skilled craftsman acquired the necessary skill to so assemble the wristwatch over many years of applying force to displace thousands of little parts when assembly previous wristwatches. That experience, based upon a much larger aggregation of previously-exerted effort, represents a genuine part of the “effort” to make this particular wristwatch and hence is fairly considered as part of the wristwatch's worth.

The conventional forces working in each person's mind are typically more-or-less constantly evaluating the value propositions that correspond to a path of least effort to thereby order their lives towards the things they value. A key reason that happens is because the actual ordering occurs in material space and people must exert real energy in pursuit of their desired ordering. People therefore naturally try to find the path with the least real energy expended that still moves them to the valued order. Accordingly, a trusted value proposition that offers a reduction of real energy will be embraced as being “good” because people will tend to be partial to anything that lowers the real energy they are required to exert while remaining consistent with their partialities.

FIG. 4 presents a space graph that illustrates many of the foregoing points. A first vector 401 represents the time required to make such a wristwatch while a second vector 402 represents the order associated with such a device (in this case, that order essentially represents the skill of the craftsman). These two vectors 401 and 402 in turn sum to form a third vector 403 that constitutes a value vector for this wristwatch. This value vector 403, in turn, is offset with respect to energy (i.e., the energy associated with manufacturing the wristwatch).

A person partial to precision and/or to physically presenting an appearance of success and status (and who presumably has the wherewithal) may, in turn, be willing to spend $100,000 for such a wristwatch. A person able to afford such a price, of course, may themselves be skilled at imposing a certain kind of order that other persons are partial to such that the amount of physical work represented by each spent dollar is small relative to an amount of dollars they receive when exercising their skill(s). (Viewed another way, wearing an expensive wristwatch may lower the effort required for such a person to communicate that their own personal success comes from being highly skilled in a certain order of high worth.)

Generally speaking, all worth comes from imposing order on the material space-time. The worth of a particular order generally increases as the skill required to impose the order increases. Accordingly, unskilled labor may exchange $10 for every hour worked where the work has a high content of unskilled physical labor while a highly-skilled data scientist may exchange $75 for every hour worked with very little accompanying physical effort.

Consider a simple example where both of these laborers are partial to a well-ordered lawn and both have a corresponding partiality vector in those regards with a same magnitude. To observe that partiality the unskilled laborer may own an inexpensive push power lawn mower that this person utilizes for an hour to mow their lawn. The data scientist, on the other hand, pays someone else $75 in this example to mow their lawn. In both cases these two individuals traded one hour of worth creation to gain the same worth (to them) in the form of a well-ordered lawn; the unskilled laborer in the form of direct physical labor and the data scientist in the form of money that required one hour of their specialized effort to earn.

This same vector-based approach can also represent various products and services. This is because products and services have worth (or not) because they can remove effort (or fail to remove effort) out of the customer's life in the direction of the order to which the customer is partial. In particular, a product has a perceived effort embedded into each dollar of cost in the same way that the customer has an amount of perceived effort embedded into each dollar earned. A customer has an increased likelihood of responding to an exchange of value if the vectors for the product and the customer's partiality are directionally aligned and where the magnitude of the vector as represented in monetary cost is somewhat greater than the worth embedded in the customer's dollar.

Put simply, the magnitude (and/or angle) of a partiality vector for a person can represent, directly or indirectly, a corresponding effort the person is willing to exert to pursue that partiality. There are various ways by which that value can be determined. As but one non-limiting example in these regards, the magnitude/angle V of a particular partiality vector can be expressed as:

$$V = [ \begin{matrix}{X}_{1} \\ ⋮ \\ {X}_{n}\end{matrix} ] [ \begin{matrix}{W}_{1} & … & {W}_{n}\end{matrix} ]$$

where X refers to any of a variety of inputs (such as those described above) that can impact the characterization of a particular partiality (and where these teachings will accommodate either or both subjective and objective inputs as desired) and W refers to weighting factors that are appropriately applied the foregoing input values (and where, for example, these weighting factors can have values that themselves reflect a particular person's consumer personality or otherwise as desired and can be static or dynamically valued in practice as desired).

In the context of a product (or service) the magnitude/angle of the corresponding vector can represent the reduction of effort that must be exerted when making use of this product to pursue that partiality, the effort that was expended in order to create the product/service, the effort that the person perceives can be personally saved while nevertheless promoting the desired order, and/or some other corresponding effort. Taken as a whole the sum of all the vectors must be perceived to increase the overall order to be considered a good product/service.

It may be noted that while reducing effort provides a very useful metric in these regards, it does not necessarily follow that a given person will always gravitate to that which most reduces effort in their life. This is at least because a given person's values (for example) will establish a baseline against which a person may eschew some goods/services that might in fact lead to a greater overall reduction of effort but which would conflict, perhaps fundamentally, with their values. As a simple illustrative example, a given person might value physical activity. Such a person could experience reduced effort (including effort represented via monetary costs) by simply sitting on their couch, but instead will pursue activities that involve that valued physical activity. That said, however, the goods and services that such a person might acquire in support of their physical activities are still likely to represent increased order in the form of reduced effort where that makes sense. For example, a person who favors rock climbing might also favor rock climbing clothing and supplies that render that activity safer to thereby reduce the effort required to prevent disorder as a consequence of a fall (and consequently increasing the good outcome of the rock climber's quality experience).

By forming reliable partiality vectors for various individuals and corresponding product characterization vectors for a variety of products and/or services, these teachings provide a useful and reliable way to identify products/services that accord with a given person's own partialities (whether those partialities are based on their values, their affinities, their preferences, or otherwise).

It is of course possible that partiality vectors may not be available yet for a given person due to a lack of sufficient specific source information from or regarding that person. In this case it may nevertheless be possible to use one or more partiality vector templates that generally represent certain groups of people that fairly include this particular person. For example, if the person's gender, age, academic status/achievements, and/or postal code are known it may be useful to utilize a template that includes one or more partiality vectors that represent some statistical average or norm of other persons matching those same characterizing parameters. (Of course, while it may be useful to at least begin to employ these teachings with certain individuals by using one or more such templates, these teachings will also accommodate modifying (perhaps significantly and perhaps quickly) such a starting point over time as part of developing a more personal set of partiality vectors that are specific to the individual.) A variety of templates could be developed based, for example, on professions, academic pursuits and achievements, nationalities and/or ethnicities, characterizing hobbies, and the like.

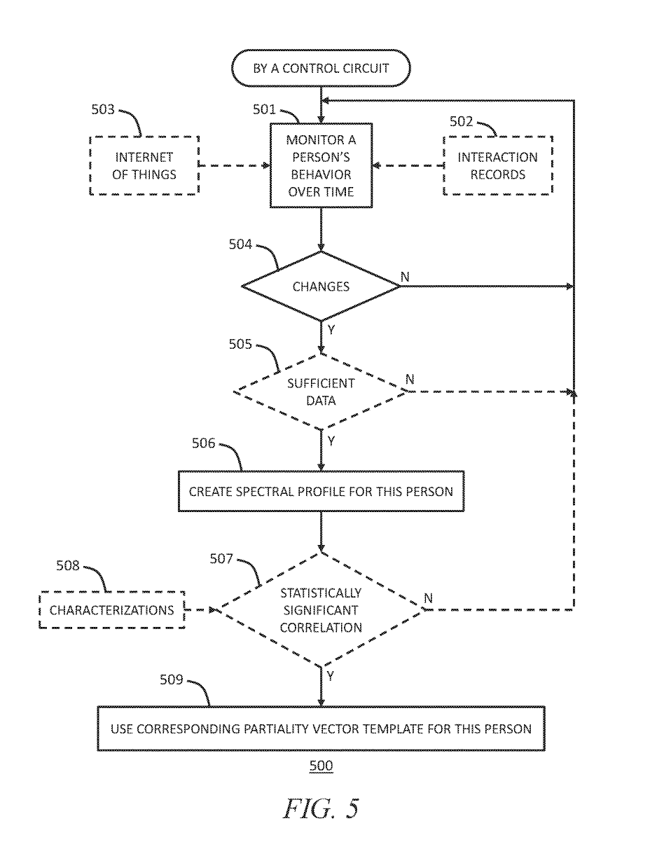

FIG. 5 presents a process 500 that illustrates yet another approach in these regards. For the sake of an illustrative example it will be presumed here that a control circuit of choice (with useful examples in these regards being presented further below) carries out one or more of the described steps/actions.

At block 501 the control circuit monitors a person's behavior over time. The range of monitored behaviors can vary with the individual and the application setting. By one approach, only behaviors that the person has specifically approved for monitoring are so monitored.

As one example in these regards, this monitoring can be based, in whole or in part, upon interaction records 502 that reflect or otherwise track, for example, the monitored person's purchases. This can include specific items purchased by the person, from whom the items were purchased, where the items were purchased, how the items were purchased (for example, at a bricks-and-mortar physical retail shopping facility or via an on-line shopping opportunity), the price paid for the items, and/or which items were returned and when), and so forth.

As another example in these regards the interaction records 502 can pertain to the social networking behaviors of the monitored person including such things as their “likes,” their posted comments, images, and tweets, affinity group affiliations, their on-line profiles, their playlists and other indicated “favorites,” and so forth. Such information can sometimes comprise a direct indication of a particular partiality or, in other cases, can indirectly point towards a particular partiality and/or indicate a relative strength of the person's partiality.

Other interaction records of potential interest include but are not limited to registered political affiliations and activities, credit reports, military-service history, educational and employment history, and so forth.

As another example, in lieu of the foregoing or in combination therewith, this monitoring can be based, in whole or in part, upon sensor inputs from the Internet of Things (IOT) 503. The Internet of Things refers to the Internet-based inter-working of a wide variety of physical devices including but not limited to wearable or carriable devices, vehicles, buildings, and other items that are embedded with electronics, software, sensors, network connectivity, and sometimes actuators that enable these objects to collect and exchange data via the Internet. In particular, the Internet of Things allows people and objects pertaining to people to be sensed and corresponding information to be transferred to remote locations via intervening network infrastructure. Some experts estimate that the Internet of Things will consist of almost 50 billion such objects by 2020. (Further description in these regards appears further herein.)

Depending upon what sensors a person encounters, information can be available regarding a person's travels, lifestyle, calorie expenditure over time, diet, habits, interests and affinities, choices and assumed risks, and so forth. This process 500 will accommodate either or both real-time or non-real time access to such information as well as either or both push and pull-based paradigms.

By monitoring a person's behavior over time a general sense of that person's daily routine can be established (sometimes referred to herein as a routine experiential base state). As a very simple illustrative example, a routine experiential base state can include a typical daily event timeline for the person that represents typical locations that the person visits and/or typical activities in which the person engages. The timeline can indicate those activities that tend to be scheduled (such as the person's time at their place of employment or their time spent at their child's sports practices) as well as visits/activities that are normal for the person though not necessarily undertaken with strict observance to a corresponding schedule (such as visits to local stores, movie theaters, and the homes of nearby friends and relatives).

At block 504 this process 500 provides for detecting changes to that established routine. These teachings are highly flexible in these regards and will accommodate a wide variety of “changes.” Some illustrative examples include but are not limited to changes with respect to a person's travel schedule, destinations visited or time spent at a particular destination, the purchase and/or use of new and/or different products or services, a subscription to a new magazine, a new Rich Site Summary (RSS) feed or a subscription to a new blog, a new “friend” or “connection” on a social networking site, a new person, entity, or cause to follow on a Twitter-like social networking service, enrollment in an academic program, and so forth.

Upon detecting a change, at optional block 505 this process 500 will accommodate assessing whether the detected change constitutes a sufficient amount of data to warrant proceeding further with the process. This assessment can comprise, for example, assessing whether a sufficient number (i.e., a predetermined number) of instances of this particular detected change have occurred over some predetermined period of time. As another example, this assessment can comprise assessing whether the specific details of the detected change are sufficient in quantity and/or quality to warrant further processing. For example, merely detecting that the person has not arrived at their usual 6 PM-Wednesday dance class may not be enough information, in and of itself, to warrant further processing, in which case the information regarding the detected change may be discarded or, in the alternative, cached for further consideration and use in conjunction or aggregation with other, later-detected changes.

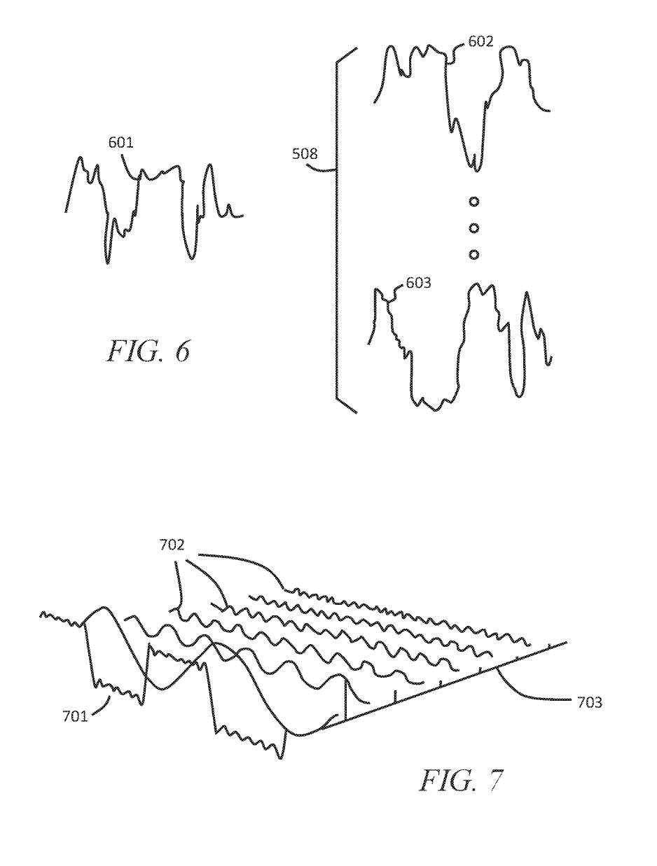

At block 507 this process 500 uses these detected changes to create a spectral profile for the monitored person. FIG. 6 provides an illustrative example in these regards with the spectral profile denoted by reference numeral 601. In this illustrative example the spectral profile 601 represents changes to the person's behavior over a given period of time (such as an hour, a day, a week, or some other temporal window of choice). Such a spectral profile can be as multidimensional as may suit the needs of a given application setting.

At optional block 507 this process 500 then provides for determining whether there is a statistically significant correlation between the aforementioned spectral profile and any of a plurality of like characterizations 508. The like characterizations 508 can comprise, for example, spectral profiles that represent an average of groupings of people who share many of the same (or all of the same) identified partialities. As a very simple illustrative example in these regards, a first such characterization 602 might represent a composite view of a first group of people who have three similar partialities but a dissimilar fourth partiality while another of the characterizations 603 might represent a composite view of a different group of people who share all four partialities.

The aforementioned “statistically significant” standard can be selected and/or adjusted to suit the needs of a given application setting. The scale or units by which this measurement can be assessed can be any known, relevant scale/unit including, but not limited to, scales such as standard deviations, cumulative percentages, percentile equivalents, Z-scores, T-scores, standard nines, and percentages in standard nines. Similarly, the threshold by which the level of statistical significance is measured/assessed can be set and selected as desired. By one approach the threshold is static such that the same threshold is employed regardless of the circumstances. By another approach the threshold is dynamic and can vary with such things as the relative size of the population of people upon which each of the characterizations 508 are based and/or the amount of data and/or the duration of time over which data is available for the monitored person.

Referring now to FIG. 7, by one approach the selected characterization (denoted by reference numeral 701 in this figure) comprises an activity profile over time of one or more human behaviors. Examples of behaviors include but are not limited to such things as repeated purchases over time of particular commodities, repeated visits over time to particular locales such as certain restaurants, retail outlets, athletic or entertainment facilities, and so forth, and repeated activities over time such as floor cleaning, dish washing, car cleaning, cooking, volunteering, and so forth. Those skilled in the art will understand and appreciate, however, that the selected characterization is not, in and of itself, demographic data (as described elsewhere herein).

More particularly, the characterization 701 can represent (in this example, for a plurality of different behaviors) each instance over the monitored/sampled period of time when the monitored/represented person engages in a particular represented behavior (such as visiting a neighborhood gym, purchasing a particular product (such as a consumable perishable or a cleaning product), interacts with a particular affinity group via social networking, and so forth). The relevant overall time frame can be chosen as desired and can range in a typical application setting from a few hours or one day to many days, weeks, or even months or years. (It will be understood by those skilled in the art that the particular characterization shown in FIG. 7 is intended to serve an illustrative purpose and does not necessarily represent or mimic any particular behavior or set of behaviors).

Generally speaking it is anticipated that many behaviors of interest will occur at regular or somewhat regular intervals and hence will have a corresponding frequency or periodicity of occurrence. For some behaviors that frequency of occurrence may be relatively often (for example, oral hygiene events that occur at least once, and often multiple times each day) while other behaviors (such as the preparation of a holiday meal) may occur much less frequently (such as only once, or only a few times, each year). For at least some behaviors of interest that general (or specific) frequency of occurrence can serve as a significant indication of a person's corresponding partialities.

By one approach, these teachings will accommodate detecting and timestamping each and every event/activity/behavior or interest as it happens. Such an approach can be memory intensive and require considerable supporting infrastructure.

The present teachings will also accommodate, however, using any of a variety of sampling periods in these regards. In some cases, for example, the sampling period per se may be one week in duration. In that case, it may be sufficient to know that the monitored person engaged in a particular activity (such as cleaning their car) a certain number of times during that week without known precisely when, during that week, the activity occurred. In other cases it may be appropriate or even desirable, to provide greater granularity in these regards. For example, it may be better to know which days the person engaged in the particular activity or even the particular hour of the day. Depending upon the selected granularity/resolution, selecting an appropriate sampling window can help reduce data storage requirements (and/or corresponding analysis/processing overhead requirements).

Although a given person's behaviors may not, strictly speaking, be continuous waves (as shown in FIG. 7) in the same sense as, for example, a radio or acoustic wave, it will nevertheless be understood that such a behavioral characterization 701 can itself be broken down into a plurality of sub-waves 702 that, when summed together, equal or at least approximate to some satisfactory degree the behavioral characterization 701 itself (The more-discrete and sometimes less-rigidly periodic nature of the monitored behaviors may introduce a certain amount of error into the corresponding sub-waves. There are various mathematically satisfactory ways by which such error can be accommodated including by use of weighting factors and/or expressed tolerances that correspond to the resultant sub-waves.)

It should also be understood that each such sub-wave can often itself be associated with one or more corresponding discrete partialities. For example, a partiality reflecting concern for the environment may, in turn, influence many of the included behavioral events (whether they are similar or dissimilar behaviors or not) and accordingly may, as a sub-wave, comprise a relatively significant contributing factor to the overall set of behaviors as monitored over time. These sub-waves (partialities) can in turn be clearly revealed and presented by employing a transform (such as a Fourier transform) of choice to yield a spectral profile 703 wherein the X axis represents frequency and the Y axis represents the magnitude of the response of the monitored person at each frequency/sub-wave of interest.

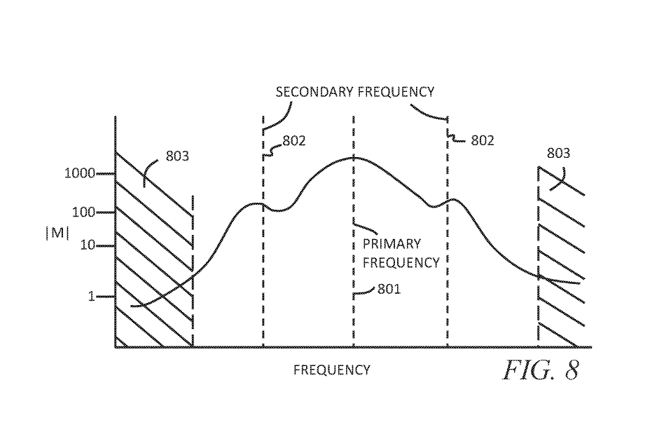

This spectral response of a given individual—which is generated from a time series of events that reflect/track that person's behavior—yields frequency response characteristics for that person that are analogous to the frequency response characteristics of physical systems such as, for example, an analog or digital filter or a second order electrical or mechanical system. Referring to FIG. 8, for many people the spectral profile of the individual person will exhibit a primary frequency 801 for which the greatest response (perhaps many orders of magnitude greater than other evident frequencies) to life is exhibited and apparent. In addition, the spectral profile may also possibly identify one or more secondary frequencies 802 above and/or below that primary frequency 801. (It may be useful in many application settings to filter out more distant frequencies 803 having considerably lower magnitudes because of a reduced likelihood of relevance and/or because of a possibility of error in those regards; in effect, these lower-magnitude signals constitute noise that such filtering can remove from consideration.)

As noted above, the present teachings will accommodate using sampling windows of varying size. By one approach the frequency of events that correspond to a particular partiality can serve as a basis for selecting a particular sampling rate to use when monitoring for such events. For example, Nyquist-based sampling rules (which dictate sampling at a rate at least twice that of the frequency of the signal of interest) can lead one to choose a particular sampling rate (and the resultant corresponding sampling window size).

As a simple illustration, if the activity of interest occurs only once a week, then using a sampling of half-a-week and sampling twice during the course of a given week will adequately capture the monitored event. If the monitored person's behavior should change, a corresponding change can be automatically made. For example, if the person in the foregoing example begins to engage in the specified activity three times a week, the sampling rate can be switched to six times per week (in conjunction with a sampling window that is resized accordingly).

By one approach, the sampling rate can be selected and used on a partiality-by-partiality basis. This approach can be especially useful when different monitoring modalities are employed to monitor events that correspond to different partialities. If desired, however, a single sampling rate can be employed and used for a plurality (or even all) partialities/behaviors. In that case, it can be useful to identify the behavior that is exemplified most often (i.e., that behavior which has the highest frequency) and then select a sampling rate that is at least twice that rate of behavioral realization, as that sampling rate will serve well and suffice for both that highest-frequency behavior and all lower-frequency behaviors as well.

It can be useful in many application settings to assume that the foregoing spectral profile of a given person is an inherent and inertial characteristic of that person and that this spectral profile, in essence, provides a personality profile of that person that reflects not only how but why this person responds to a variety of life experiences. More importantly, the partialities expressed by the spectral profile for a given person will tend to persist going forward and will not typically change significantly in the absence of some powerful external influence (including but not limited to significant life events such as, for example, marriage, children, loss of job, promotion, and so forth).

In any event, by knowing a priori the particular partialities (and corresponding strengths) that underlie the particular characterization 701, those partialities can be used as an initial template for a person whose own behaviors permit the selection of that particular characterization 701. In particular, those particularities can be used, at least initially, for a person for whom an amount of data is not otherwise available to construct a similarly rich set of partiality information.

As a very specific and non-limiting example, per these teachings the choice to make a particular product can include consideration of one or more value systems of potential customers. When considering persons who value animal rights, a product conceived to cater to that value proposition may require a corresponding exertion of additional effort to order material space-time such that the product is made in a way that (A) does not harm animals and/or (even better) (B) improves life for animals (for example, eggs obtained from free range chickens). The reason a person exerts effort to order material space-time is because they believe it is good to do and/or not good to not do so. When a person exerts effort to do good (per their personal standard of “good”) and if that person believes that a particular order in material space-time (that includes the purchase of a particular product) is good to achieve, then that person will also believe that it is good to buy as much of that particular product (in order to achieve that good order) as their finances and needs reasonably permit (all other things being equal).

The aforementioned additional effort to provide such a product can (typically) convert to a premium that adds to the price of that product. A customer who puts out extra effort in their life to value animal rights will typically be willing to pay that extra premium to cover that additional effort exerted by the company. By one approach a magnitude that corresponds to the additional effort exerted by the company can be added to the person's corresponding value vector because a product or service has worth to the extent that the product/service allows a person to order material space-time in accordance with their own personal value system while allowing that person to exert less of their own effort in direct support of that value (since money is a scalar form of effort).

By one approach there can be hundreds or even thousands of identified partialities. In this case, if desired, each product/service of interest can be assessed with respect to each and every one of these partialities and a corresponding partiality vector formed to thereby build a collection of partiality vectors that collectively characterize the product/service. As a very simple example in these regards, a given laundry detergent might have a cleanliness partiality vector with a relatively high magnitude (representing the effectiveness of the detergent), a ecology partiality vector that might be relatively low or possibly even having a negative magnitude (representing an ecologically disadvantageous effect of the detergent post usage due to increased disorder in the environment), and a simple-life partiality vector with only a modest magnitude (representing the relative ease of use of the detergent but also that the detergent presupposes that the user has a modern washing machine). Other partiality vectors for this detergent, representing such things as nutrition or mental acuity, might have magnitudes of zero.

As mentioned above, these teachings can accommodate partiality vectors having a negative magnitude. Consider, for example, a partiality vector representing a desire to order things to reduce one's so-called carbon footprint. A magnitude of zero for this vector would indicate a completely neutral effect with respect to carbon emissions while any positive-valued magnitudes would represent a net reduction in the amount of carbon in the atmosphere, hence increasing the ability of the environment to be ordered. Negative magnitudes would represent the introduction of carbon emissions that increases disorder of the environment (for example, as a result of manufacturing the product, transporting the product, and/or using the product)

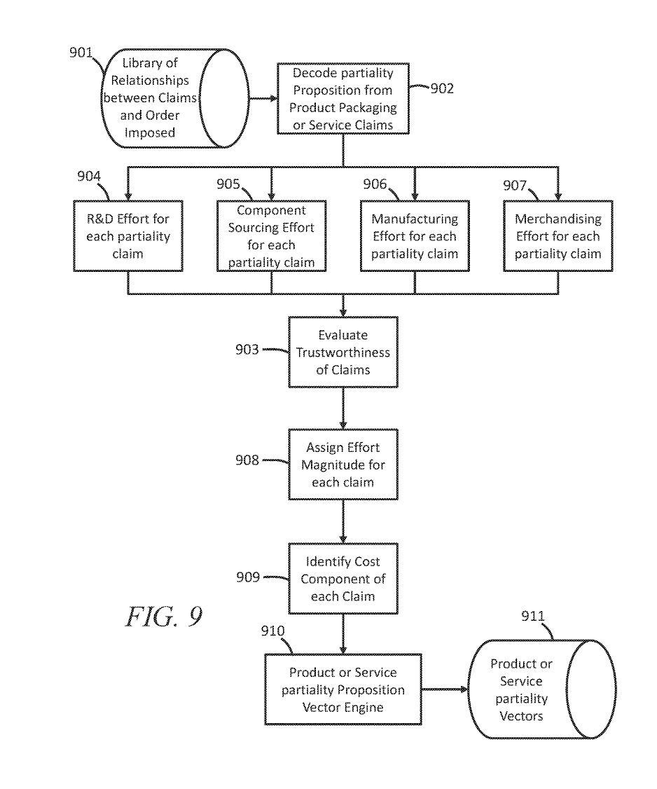

FIG. 9 presents one non-limiting illustrative example in these regards. The illustrated process presumes the availability of a library 901 of correlated relationships between product/service claims and particular imposed orders. Examples of product/service claims include such things as claims that a particular product results in cleaner laundry or household surfaces, or that a particular product is made in a particular political region (such as a particular state or country), or that a particular product is better for the environment, and so forth. The imposed orders to which such claims are correlated can reflect orders as described above that pertain to corresponding partialities.

At block 902 this process provides for decoding one or more partiality propositions from specific product packaging (or service claims). For example, the particular textual/graphics-based claims presented on the packaging of a given product can be used to access the aforementioned library 901 to identify one or more corresponding imposed orders from which one or more corresponding partialities can then be identified.

At block 903 this process provides for evaluating the trustworthiness of the aforementioned claims. This evaluation can be based upon any one or more of a variety of data points as desired. FIG. 9 illustrates four significant possibilities in these regards. For example, at block 904 an actual or estimated research and development effort can be quantified for each claim pertaining to a partiality. At block 905 an actual or estimated component sourcing effort for the product in question can be quantified for each claim pertaining to a partiality. At block 906 an actual or estimated manufacturing effort for the product in question can be quantified for each claim pertaining to a partiality. And at block 907 an actual or estimated merchandising effort for the product in question can be quantified for each claim pertaining to a partiality.

If desired, a product claim lacking sufficient trustworthiness may simply be excluded from further consideration. By another approach the product claim can remain in play but a lack of trustworthiness can be reflected, for example, in a corresponding partiality vector direction or magnitude for this particular product.

At block 908 this process provides for assigning an effort magnitude for each evaluated product/service claim. That effort can constitute a one-dimensional effort (reflecting, for example, only the manufacturing effort) or can constitute a multidimensional effort that reflects, for example, various categories of effort such as the aforementioned research and development effort, component sourcing effort, manufacturing effort, and so forth.

At block 909 this process provides for identifying a cost component of each claim, this cost component representing a monetary value. At block 910 this process can use the foregoing information with a product/service partiality propositions vector engine to generate a library 911 of one or more corresponding partiality vectors for the processed products/services. Such a library can then be used as described herein in conjunction with partiality vector information for various persons to identify, for example, products/services that are well aligned with the partialities of specific individuals.

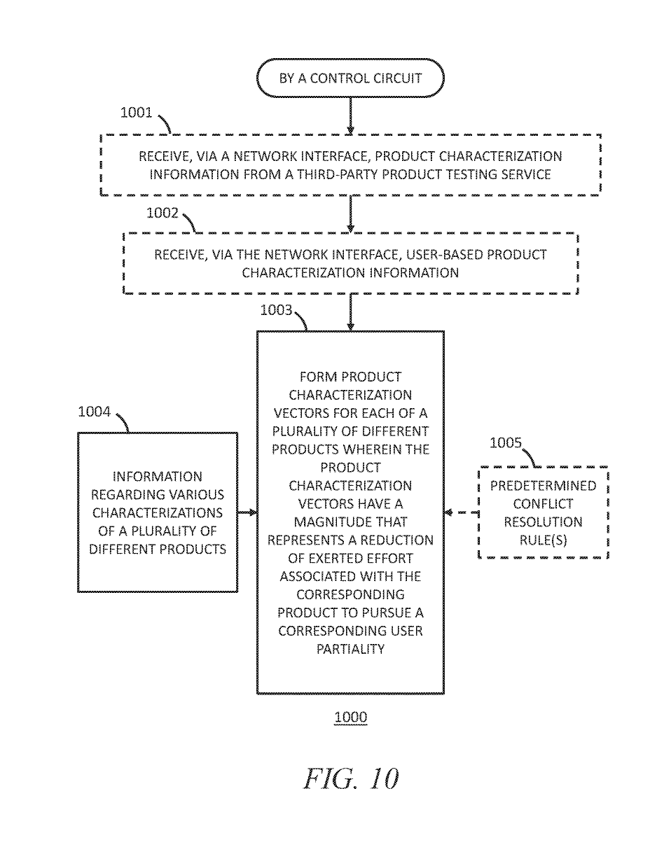

FIG. 10 provides another illustrative example in these same regards and may be employed in lieu of the foregoing or in total or partial combination therewith. Generally speaking, this process 1000 serves to facilitate the formation of product characterization vectors for each of a plurality of different products where the magnitude of the vector length (and/or the vector angle) has a magnitude that represents a reduction of exerted effort associated with the corresponding product to pursue a corresponding user partiality.

By one approach, and as illustrated in FIG. 10, this process 1000 can be carried out by a control circuit of choice. Specific examples of control circuits are provided elsewhere herein.

As described further herein in detail, this process 1000 makes use of information regarding various characterizations of a plurality of different products. These teachings are highly flexible in practice and will accommodate a wide variety of possible information sources and types of information. By one optional approach, and as shown at optional block 1001, the control circuit can receive (for example, via a corresponding network interface of choice) product characterization information from a third-party product testing service. The magazine/web resource Consumers Report provides one useful example in these regards. Such a resource provides objective content based upon testing, evaluation, and comparisons (and sometimes also provides subjective content regarding such things as aesthetics, ease of use, and so forth) and this content, provided as-is or pre-processed as desired, can readily serve as useful third-party product testing service product characterization information.

As another example, any of a variety of product-testing blogs that are published on the Internet can be similarly accessed and the product characterization information available at such resources harvested and received by the control circuit. (The expression “third party” will be understood to refer to an entity other than the entity that operates/controls the control circuit and other than the entity that provides the corresponding product itself.)

As another example, and as illustrated at optional block 1002, the control circuit can receive (again, for example, via a network interface of choice) user-based product characterization information. Examples in these regards include but are not limited to user reviews provided on-line at various retail sites for products offered for sale at such sites. The reviews can comprise metricized content (for example, a rating expressed as a certain number of stars out of a total available number of stars, such as 3 stars out of 5 possible stars) and/or text where the reviewers can enter their objective and subjective information regarding their observations and experiences with the reviewed products. In this case, “user-based” will be understood to refer to users who are not necessarily professional reviewers (though it is possible that content from such persons may be included with the information provided at such a resource) but who presumably purchased the product being reviewed and who have personal experience with that product that forms the basis of their review. By one approach the resource that offers such content may constitute a third party as defined above, but these teachings will also accommodate obtaining such content from a resource operated or sponsored by the enterprise that controls/operates this control circuit.

In any event, this process 1000 provides for accessing (see block 1004) information regarding various characterizations of each of a plurality of different products. This information 1004 can be gleaned as described above and/or can be obtained and/or developed using other resources as desired. As one illustrative example in these regards, the manufacturer and/or distributor of certain products may source useful content in these regards.

These teachings will accommodate a wide variety of information sources and types including both objective characterizing and/or subjective characterizing information for the aforementioned products.

Examples of objective characterizing information include, but are not limited to, ingredients information (i.e., specific components/materials from which the product is made), manufacturing locale information (such as country of origin, state of origin, municipality of origin, region of origin, and so forth), efficacy information (such as metrics regarding the relative effectiveness of the product to achieve a particular end-use result), cost information (such as per product, per ounce, per application or use, and so forth), availability information (such as present in-store availability, on-hand inventory availability at a relevant distribution center, likely or estimated shipping date, and so forth), environmental impact information (regarding, for example, the materials from which the product is made, one or more manufacturing processes by which the product is made, environmental impact associated with use of the product, and so forth), and so forth.

Examples of subjective characterizing information include but are not limited to user sensory perception information (regarding, for example, heaviness or lightness, speed of use, effort associated with use, smell, and so forth), aesthetics information (regarding, for example, how attractive or unattractive the product is in appearance, how well the product matches or accords with a particular design paradigm or theme, and so forth), trustworthiness information (regarding, for example, user perceptions regarding how likely the product is perceived to accomplish a particular purpose or to avoid causing a particular collateral harm), trendiness information, and so forth.

This information 1004 can be curated (or not), filtered, sorted, weighted (in accordance with a relative degree of trust, for example, accorded to a particular source of particular information), and otherwise categorized and utilized as desired. As one simple example in these regards, for some products it may be desirable to only use relatively fresh information (i.e., information not older than some specific cut-off date) while for other products it may be acceptable (or even desirable) to use, in lieu of fresh information or in combination therewith, relatively older information. As another simple example, it may be useful to use only information from one particular geographic region to characterize a particular product and to therefore not use information from other geographic regions.

At block 1003 the control circuit uses the foregoing information 1004 to form product characterization vectors for each of the plurality of different products. By one approach these product characterization vectors have a magnitude (for the length of the vector and/or the angle of the vector) that represents a reduction of exerted effort associated with the corresponding product to pursue a corresponding user partiality (as is otherwise discussed herein).

It is possible that a conflict will become evident as between various ones of the aforementioned items of information 1004. In particular, the available characterizations for a given product may not all be the same or otherwise in accord with one another. In some cases it may be appropriate to literally or effectively calculate and use an average to accommodate such a conflict. In other cases it may be useful to use one or more other predetermined conflict resolution rules 1005 to automatically resolve such conflicts when forming the aforementioned product characterization vectors.

These teachings will accommodate any of a variety of rules in these regards. By one approach, for example, the rule can be based upon the age of the information (where, for example the older (or newer, if desired) data is preferred or weighted more heavily than the newer (or older, if desired) data. By another approach, the rule can be based upon a number of user reviews upon which the user-based product characterization information is based (where, for example, the rule specifies that whichever user-based product characterization information is based upon a larger number of user reviews will prevail in the event of a conflict). By another approach, the rule can be based upon information regarding historical accuracy of information from a particular information source (where, for example, the rule specifies that information from a source with a better historical record of accuracy shall prevail over information from a source with a poorer historical record of accuracy in the event of a conflict).

By yet another approach, the rule can be based upon social media. For example, social media-posted reviews may be used as a tie-breaker in the event of a conflict between other more-favored sources. By another approach, the rule can be based upon a trending analysis. And by yet another approach the rule can be based upon the relative strength of brand awareness for the product at issue (where, for example, the rule specifies resolving a conflict in favor of a more favorable characterization when dealing with a product from a strong brand that evidences considerable consumer goodwill and trust).

It will be understood that the foregoing examples are intended to serve an illustrative purpose and are not offered as an exhaustive listing in these regards. It will also be understood that any two or more of the foregoing rules can be used in combination with one another to resolve the aforementioned conflicts.

By one approach the aforementioned product characterization vectors are formed to serve as a universal characterization of a given product. By another approach, however, the aforementioned information 1004 can be used to form product characterization vectors for a same characterization factor for a same product to thereby correspond to different usage circumstances of that same product. Those different usage circumstances might comprise, for example, different geographic regions of usage, different levels of user expertise (where, for example, a skilled, professional user might have different needs and expectations for the product than a casual, lay user), different levels of expected use, and so forth. In particular, the different vectorized results for a same characterization factor for a same product may have differing magnitudes from one another to correspond to different amounts of reduction of the exerted effort associated with that product under the different usage circumstances.

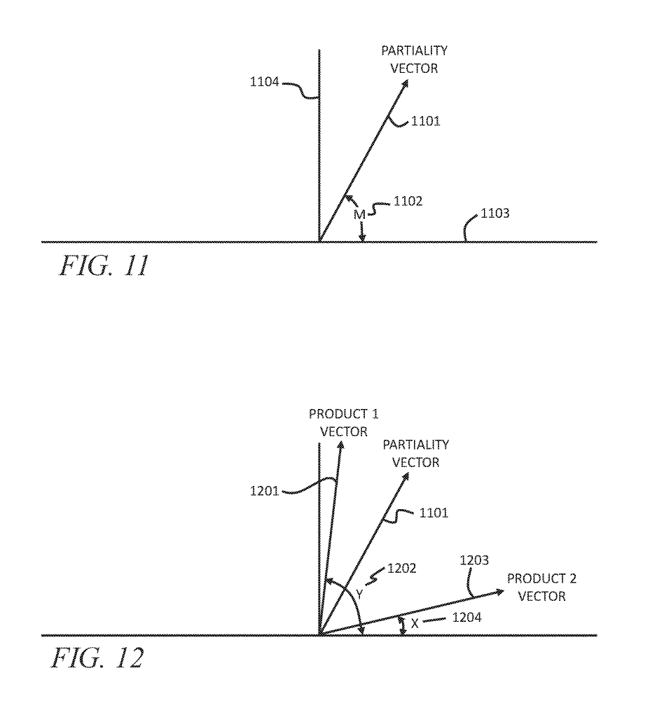

As noted above, the magnitude corresponding to a particular partiality vector for a particular person can be expressed by the angle of that partiality vector. FIG. 11 provides an illustrative example in these regards. In this example the partiality vector 1101 has an angle M 1102 (and where the range of available positive magnitudes range from a minimal magnitude represented by 0° (as denoted by reference numeral 1103) to a maximum magnitude represented by 90° (as denoted by reference numeral 1104)). Accordingly, the person to whom this partiality vector 1001 pertains has a relatively strong (but not absolute) belief in an amount of good that comes from an order associated with that partiality.

FIG. 12, in turn, presents that partiality vector 1101 in context with the product characterization vectors 1201 and 1203 for a first product and a second product, respectively. In this example the product characterization vector 1201 for the first product has an angle Y 1202 that is greater than the angle M 1102 for the aforementioned partiality vector 1101 by a relatively small amount while the product characterization vector 1203 for the second product has an angle X 1204 that is considerably smaller than the angle M 1102 for the partiality vector 1101.

Since, in this example, the angles of the various vectors represent the magnitude of the person's specified partiality or the extent to which the product aligns with that partiality, respectively, vector dot product calculations can serve to help identify which product best aligns with this partiality. Such an approach can be particularly useful when the lengths of the vectors are allowed to vary as a function of one or more parameters of interest. As those skilled in the art will understand, a vector dot product is an algebraic operation that takes two equal-length sequences of numbers (in this case, coordinate vectors) and returns a single number.

This operation can be defined either algebraically or geometrically. Algebraically, it is the sum of the products of the corresponding entries of the two sequences of numbers. Geometrically, it is the product of the Euclidean magnitudes of the two vectors and the cosine of the angle between them. The result is a scalar rather than a vector. As regards the present illustrative example, the resultant scaler value for the vector dot product of the product 1 vector 1201 with the partiality vector 1101 will be larger than the resultant scaler value for the vector dot product of the product 2 vector 1203 with the partiality vector 1101. Accordingly, when using vector angles to impart this magnitude information, the vector dot product operation provides a simple and convenient way to determine proximity between a particular partiality and the performance/properties of a particular product to thereby greatly facilitate identifying a best product amongst a plurality of candidate products.

By way of further illustration, consider an example where a particular consumer as a strong partiality for organic produce and is financially able to afford to pay to observe that partiality. A dot product result for that person with respect to a product characterization vector(s) for organic apples that represent a cost of $10 on a weekly basis (i.e., Cv·P1v) might equal (1,1), hence yielding a scalar result of ∥1∥ (where Cv refers to the corresponding partiality vector for this person and P1v represents the corresponding product characterization vector for these organic apples). Conversely, a dot product result for this same person with respect to a product characterization vector(s) for non-organic apples that represent a cost of $5 on a weekly basis (i.e., Cv·P2v) might instead equal (1,0), hence yielding a scalar result of ∥1/2∥. Accordingly, although the organic apples cost more than the non-organic apples, the dot product result for the organic apples exceeds the dot product result for the non-organic apples and therefore identifies the more expensive organic apples as being the best choice for this person.

To continue with the foregoing example, consider now what happens when this person subsequently experiences some financial misfortune (for example, they lose their job and have not yet found substitute employment). Such an event can present the “force” necessary to alter the previously-established “inertia” of this person's steady-state partialities; in particular, these negatively-changed financial circumstances (in this example) alter this person's budget sensitivities (though not, of course their partiality for organic produce as compared to non-organic produce). The scalar result of the dot product for the $5/week non-organic apples may remain the same (i.e., in this example, ∥1/2∥), but the dot product for the $10/week organic apples may now drop (for example, to ∥1/2∥ as well). Dropping the quantity of organic apples purchased, however, to reflect the tightened financial circumstances for this person may yield a better dot product result. For example, purchasing only $5 (per week) of organic apples may produce a dot product result of ∥1∥. The best result for this person, then, under these circumstances, is a lesser quantity of organic apples rather than a larger quantity of non-organic apples.

In a typical application setting, it is possible that this person's loss of employment is not, in fact, known to the system. Instead, however, this person's change of behavior (i.e., reducing the quantity of the organic apples that are purchased each week) might well be tracked and processed to adjust one or more partialities (either through an addition or deletion of one or more partialities and/or by adjusting the corresponding partiality magnitude) to thereby yield this new result as a preferred result.

The foregoing simple examples clearly illustrate that vector dot product approaches can be a simple yet powerful way to quickly eliminate some product options while simultaneously quickly highlighting one or more product options as being especially suitable for a given person.

Such vector dot product calculations and results, in turn, help illustrate another point as well. As noted above, sine waves can serve as a potentially useful way to characterize and view partiality information for both people and products/services. In those regards, it is worth noting that a vector dot product result can be a positive, zero, or even negative value. That, in turn, suggests representing a particular solution as a normalization of the dot product value relative to the maximum possible value of the dot product. Approached this way, the maximum amplitude of a particular sine wave will typically represent a best solution.

Taking this approach further, by one approach the frequency (or, if desired, phase) of the sine wave solution can provide an indication of the sensitivity of the person to product choices (for example, a higher frequency can indicate a relatively highly reactive sensitivity while a lower frequency can indicate the opposite). A highly sensitive person is likely to be less receptive to solutions that are less than fully optimum and hence can help to narrow the field of candidate products while, conversely, a less sensitive person is likely to be more receptive to solutions that are less than fully optimum and can help to expand the field of candidate products.

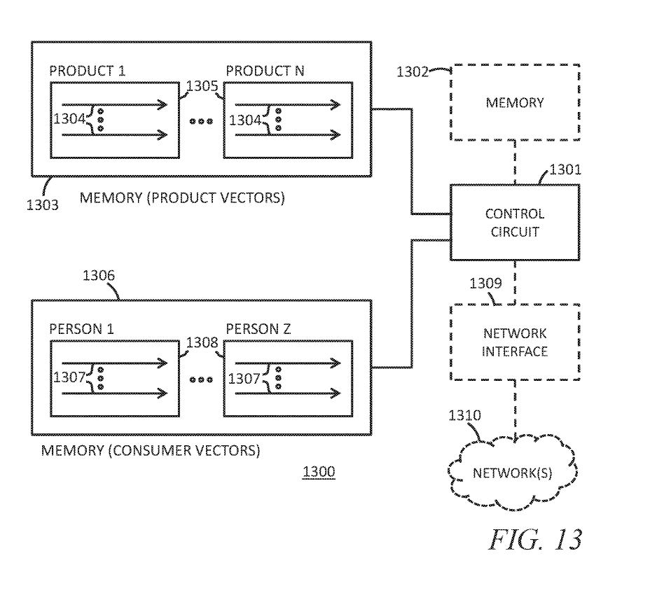

FIG. 13 presents an illustrative apparatus 1300 for conducting, containing, and utilizing the foregoing content and capabilities. In this particular example, the enabling apparatus 1300 includes a control circuit 1301. Being a “circuit,” the control circuit 1301 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 1301 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 1301 is configured (for example, by using corresponding programming as will be well understood by those skilled in the art) to carry out one or more of the steps, actions, and/or functions described herein.

By one optional approach the control circuit 1301 operably couples to a memory 1302. This memory 1302 may be integral to the control circuit 1301 or can be physically discrete (in whole or in part) from the control circuit 1301 as desired. This memory 1302 can also be local with respect to the control circuit 1301 (where, for example, both share a common circuit board, chassis, power supply, and/or housing) or can be partially or wholly remote with respect to the control circuit 1301 (where, for example, the memory 1302 is physically located in another facility, metropolitan area, or even country as compared to the control circuit 1301).

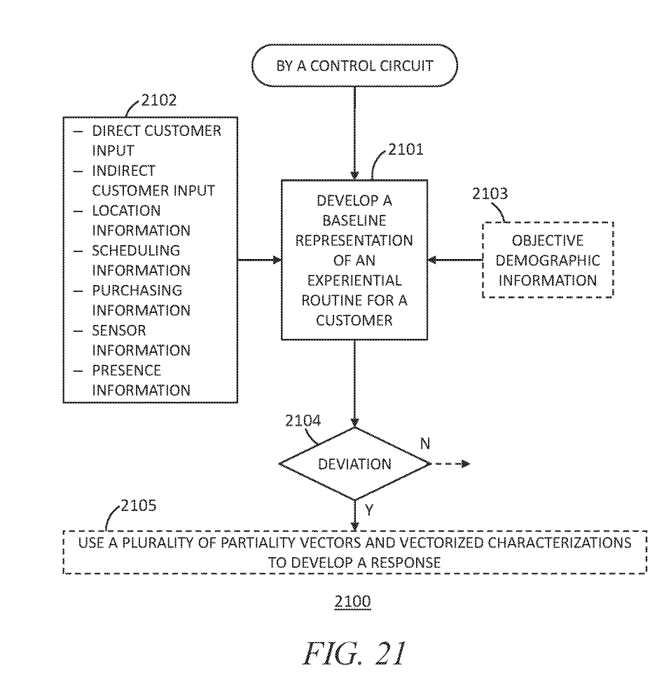

This memory 1302 can serve, for example, to non-transitorily store the computer instructions that, when executed by the control circuit 1301, cause the control circuit 1301 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).) This memory 602 can also serve to store, for example, information regarding a routine experiential base state for one or more customers (as described herein in more detail) and/or expert inputs pertaining, for example, to identifying customer aspirations, the extent of a customer's aspirations, and products/services that can/will assist a customer to realize a particular aspiration (e.g., see the description of FIGS. 21-25 and the corresponding description).

Either stored in this memory 1302 or, as illustrated, in a separate memory 1303 are the vectorized characterizations 1304 for each of a plurality of products 1305 (represented here by a first product through an Nth product where “N” is an integer greater than “1”). In addition, and again either stored in this memory 1302 or, as illustrated, in a separate memory 1306 are the vectorized characterizations 1307 for each of a plurality of individual persons 1308 (represented here by a first person through a Zth person wherein “Z” is also an integer greater than “1”).

In this example the control circuit 1301 also operably couples to a network interface 1309. So configured the control circuit 1301 can communicate with other elements (both within the apparatus 1300 and external thereto) via the network interface 1309. Network interfaces, including both wireless and non-wireless platforms, are well understood in the art and require no particular elaboration here. This network interface 1309 can compatibly communicate via whatever network or networks 1310 may be appropriate to suit the particular needs of a given application setting. Both communication networks and network interfaces are well understood areas of prior art endeavor and therefore no further elaboration will be provided here in those regards for the sake of brevity.

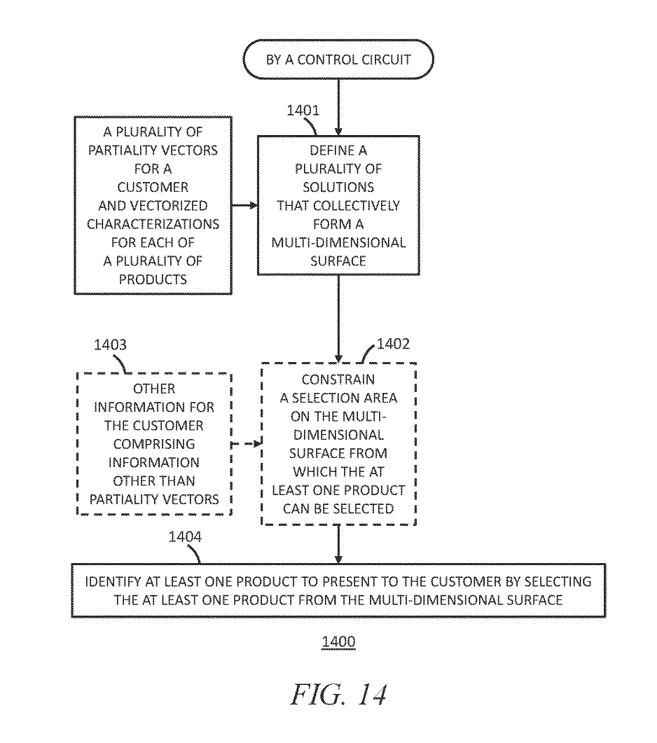

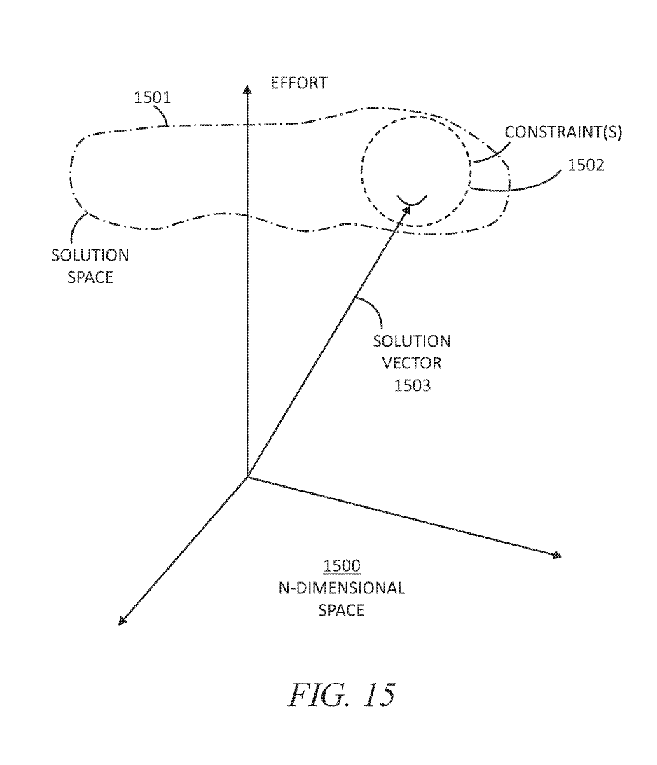

By one approach, and referring now to FIG. 14, the control circuit 1301 is configured to use the aforementioned partiality vectors 1307 and the vectorized product characterizations 1304 to define a plurality of solutions that collectively form a multidimensional surface (per block 1401). FIG. 15 provides an illustrative example in these regards. FIG. 15 represents an N-dimensional space 1500 and where the aforementioned information for a particular customer yielded a multi-dimensional surface denoted by reference numeral 1501. (The relevant value space is an N-dimensional space where the belief in the value of a particular ordering of one's life only acts on value propositions in that space as a function of a least-effort functional relationship.)

Generally speaking, this surface 1501 represents all possible solutions based upon the foregoing information. Accordingly, in a typical application setting this surface 1501 will contain/represent a plurality of discrete solutions. That said, and also in a typical application setting, not all of those solutions will be similarly preferable. Instead, one or more of those solutions may be particularly useful/appropriate at a given time, in a given place, for a given customer.

With continued reference to FIGS. 14 and 15, at optional block 1402 the control circuit 1301 can be configured to use information for the customer 1403 (other than the aforementioned partiality vectors 1307) to constrain a selection area 1502 on the multi-dimensional surface 1501 from which at least one product can be selected for this particular customer. By one approach, for example, the constraints can be selected such that the resultant selection area 1502 represents the best 95th percentile of the solution space. Other target sizes for the selection area 1502 are of course possible and may be useful in a given application setting.

The aforementioned other information 1403 can comprise any of a variety of information types. By one approach, for example, this other information comprises objective information. (As used herein, “objective information” will be understood to constitute information that is not influenced by personal feelings or opinions and hence constitutes unbiased, neutral facts.)

One particularly useful category of objective information comprises objective information regarding the customer. Examples in these regards include, but are not limited to, location information regarding a past, present, or planned/scheduled future location of the customer, budget information for the customer or regarding which the customer must strive to adhere (such that, by way of example, a particular product/solution area may align extremely well with the customer's partialities but is well beyond that which the customer can afford and hence can be reasonably excluded from the selection area 1502), age information for the customer, and gender information for the customer. Another example in these regards is information comprising objective logistical information regarding providing particular products to the customer. Examples in these regards include but are not limited to current or predicted product availability, shipping limitations (such as restrictions or other conditions that pertain to shipping a particular product to this particular customer at a particular location), and other applicable legal limitations (pertaining, for example, to the legality of a customer possessing or using a particular product at a particular location).

At block 1404 the control circuit 1301 can then identify at least one product to present to the customer by selecting that product from the multi-dimensional surface 1501. In the example of FIG. 15, where constraints have been used to define a reduced selection area 1502, the control circuit 1301 is constrained to select that product from within that selection area 1502. For example, and in accordance with the description provided herein, the control circuit 1301 can select that product via solution vector 1503 by identifying a particular product that requires a minimal expenditure of customer effort while also remaining compliant with one or more of the applied objective constraints based, for example, upon objective information regarding the customer and/or objective logistical information regarding providing particular products to the customer.

So configured, and as a simple example, the control circuit 1301 may respond per these teachings to learning that the customer is planning a party that will include seven other invited individuals. The control circuit 1301 may therefore be looking to identify one or more particular beverages to present to the customer for consideration in those regards. The aforementioned partiality vectors 1307 and vectorized product characterizations 1304 can serve to define a corresponding multi-dimensional surface 1501 that identifies various beverages that might be suitable to consider in these regards.

Objective information regarding the customer and/or the other invited persons, however, might indicate that all or most of the participants are not of legal drinking age. In that case, that objective information may be utilized to constrain the available selection area 1502 to beverages that contain no alcohol. As another example in these regards, the control circuit 1301 may have objective information that the party is to be held in a state park that prohibits alcohol and may therefore similarly constrain the available selection area 1502 to beverages that contain no alcohol.

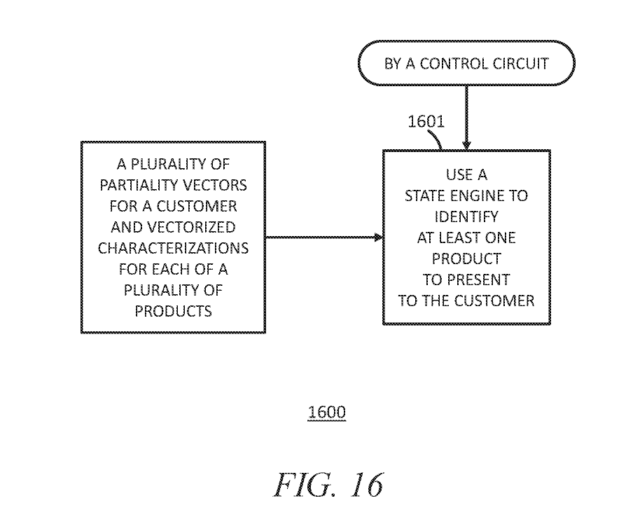

As described above, the aforementioned control circuit 1301 can utilize information including a plurality of partiality vectors for a particular customer along with vectorized product characterizations for each of a plurality of products to identify at least one product to present to a customer. By one approach 1600, and referring to FIG. 16, the control circuit 1301 can be configured as (or to use) a state engine to identify such a product (as indicated at block 1601). As used herein, the expression “state engine” will be understood to refer to a finite-state machine, also sometimes known as a finite-state automaton or simply as a state machine.

Generally speaking, a state engine is a basic approach to designing both computer programs and sequential logic circuits. A state engine has only a finite number of states and can only be in one state at a time. A state engine can change from one state to another when initiated by a triggering event or condition often referred to as a transition. Accordingly, a particular state engine is defined by a list of its states, its initial state, and the triggering condition for each transition.

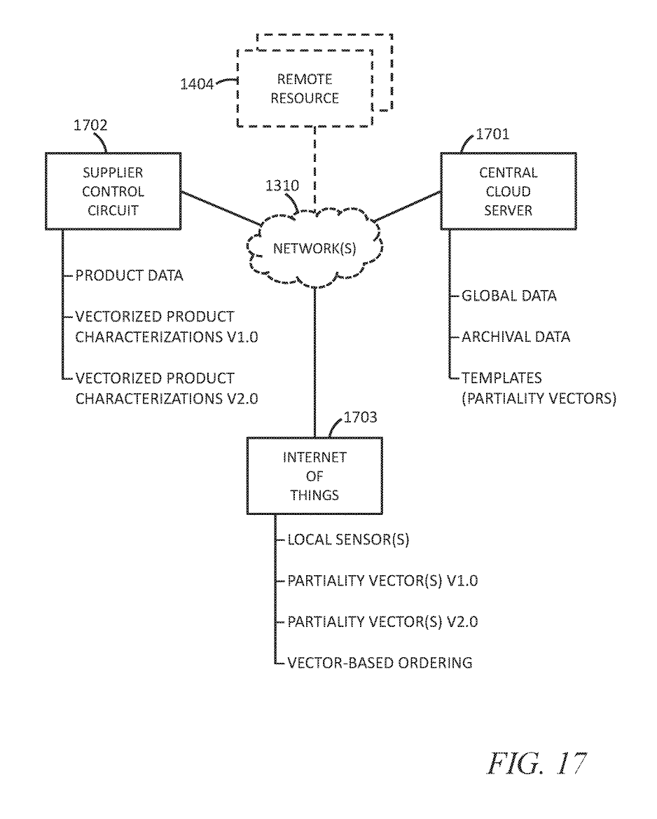

It will be appreciated that the apparatus 1300 described above can be viewed as a literal physical architecture or, if desired, as a logical construct. For example, these teachings can be enabled and operated in a highly centralized manner (as might be suggested when viewing that apparatus 1300 as a physical construct) or, conversely, can be enabled and operated in a highly decentralized manner. FIG. 17 provides an example as regards the latter.

In this illustrative example a central cloud server 1701, a supplier control circuit 1702, and the aforementioned Internet of Things 1703 communicate via the aforementioned network 1310.

The central cloud server 1701 can receive, store, and/or provide various kinds of global data (including, for example, general demographic information regarding people and places, profile information for individuals, product descriptions and reviews, and so forth), various kinds of archival data (including, for example, historical information regarding the aforementioned demographic and profile information and/or product descriptions and reviews), and partiality vector templates as described herein that can serve as starting point general characterizations for particular individuals as regards their partialities. Such information may constitute a public resource and/or a privately-curated and accessed resource as desired. (It will also be understood that there may be more than one such central cloud server 1701 that store identical, overlapping, or wholly distinct content.)

The supplier control circuit 1702 can comprise a resource that is owned and/or operated on behalf of the suppliers of one or more products (including but not limited to manufacturers, wholesalers, retailers, and even resellers of previously-owned products). This resource can receive, process and/or analyze, store, and/or provide various kinds of information. Examples include but are not limited to product data such as marketing and packaging content (including textual materials, still images, and audio-video content), operators and installers manuals, recall information, professional and non-professional reviews, and so forth.

Another example comprises vectorized product characterizations as described herein. More particularly, the stored and/or available information can include both prior vectorized product characterizations (denoted in FIG. 17 by the expression “vectorized product characterizations V1.0”) for a given product as well as subsequent, updated vectorized product characterizations (denoted in FIG. 17 by the expression “vectorized product characterizations V2.0”) for the same product. Such modifications may have been made by the supplier control circuit 1702 itself or may have been made in conjunction with or wholly by an external resource as desired.

The Internet of Things 1703 can comprise any of a variety of devices and components that may include local sensors that can provide information regarding a corresponding user's circumstances, behaviors, and reactions back to, for example, the aforementioned central cloud server 1701 and the supplier control circuit 1702 to facilitate the development of corresponding partiality vectors for that corresponding user. Again, however, these teachings will also support a decentralized approach. In many cases devices that are fairly considered to be members of the Internet of Things 1703 constitute network edge elements (i.e., network elements deployed at the edge of a network). In some case the network edge element is configured to be personally carried by the person when operating in a deployed state. Examples include but are not limited to so-called smart phones, smart watches, fitness monitors that are worn on the body, and so forth. In other cases, the network edge element may be configured to not be personally carried by the person when operating in a deployed state. This can occur when, for example, the network edge element is too large and/or too heavy to be reasonably carried by an ordinary average person. This can also occur when, for example, the network edge element has operating requirements ill-suited to the mobile environment that typifies the average person.

For example, a so-called smart phone can itself include a suite of partiality vectors for a corresponding user (i.e., a person that is associated with the smart phone which itself serves as a network edge element) and employ those partiality vectors to facilitate vector-based ordering (either automated or to supplement the ordering being undertaken by the user) as is otherwise described herein. In that case, the smart phone can obtain corresponding vectorized product characterizations from a remote resource such as, for example, the aforementioned supplier control circuit 1702 and use that information in conjunction with local partiality vector information to facilitate the vector-based ordering.

Also, if desired, the smart phone in this example can itself modify and update partiality vectors for the corresponding user. To illustrate this idea in FIG. 17, this device can utilize, for example, information gained at least in part from local sensors to update a locally-stored partiality vector (represented in FIG. 17 by the expression “partiality vector V1.0”) to obtain an updated locally-stored partiality vector (represented in FIG. 17 by the expression “partiality vector V2.0”). Using this approach, a user's partiality vectors can be locally stored and utilized. Such an approach may better comport with a particular user's privacy concerns.

It will be understood that the smart phone employed in the immediate example is intended to serve in an illustrative capacity and is not intended to suggest any particular limitations in these regards. In fact, any of a wide variety of Internet of Things devices/components could be readily configured in the same regards. As one simple example in these regards, a computationally-capable networked refrigerator could be configured to order appropriate perishable items for a corresponding user as a function of that user's partialities.

Presuming a decentralized approach, these teachings will accommodate any of a variety of other remote resources 1704. These remote resources 1704 can, in turn, provide static or dynamic information and/or interaction opportunities or analytical capabilities that can be called upon by any of the above-described network elements. Examples include but are not limited to voice recognition, pattern and image recognition, facial recognition, statistical analysis, computational resources, encryption and decryption services, fraud and misrepresentation detection and prevention services, digital currency support, and so forth.

Illustrative examples in these regards are provided below where appropriate.

As already suggested above, these approaches provide powerful ways for identifying products and/or services that a given person, or a given group of persons, may likely wish to buy to the exclusion of other options. When the magnitude and direction of the relevant/required meta-force vector that comes from the perceived effort to impose order is known, these teachings will facilitate, for example, engineering a product or service containing potential energy in the precise ordering direction to provide a total reduction of effort. Since people generally take the path of least effort (consistent with their partialities) they will typically accept such a solution.

As one simple illustrative example, a person who exhibits a partiality for food products that emphasize health, natural ingredients, and a concern to minimize sugars and fats may be presumed to have a similar partiality for pet foods because such partialities may be based on a value system that extends beyond themselves to other living creatures within their sphere of concern. If other data is available to indicate that this person in fact has, for example, two pet dogs, these partialities can be used to identify dog food products having well-aligned vectors in these same regards. This person could then be solicited to purchase such dog food products using any of a variety of solicitation approaches (including but not limited to general informational advertisements, discount coupons or rebate offers, sales calls, free samples, and so forth).

As another simple example, the approaches described herein can be used to filter out products/services that are not likely to accord well with a given person's partiality vectors. In particular, rather than emphasizing one particular product over another, a given person can be presented with a group of products that are available to purchase where all of the vectors for the presented products align to at least some predetermined degree of alignment/accord and where products that do not meet this criterion are simply not presented.

And as yet another simple example, a particular person may have a strong partiality towards both cleanliness and orderliness. The strength of this partiality might be measured in part, for example, by the physical effort they exert by consistently and promptly cleaning their kitchen following meal preparation activities. If this person were looking for lawn care services, their partiality vector(s) in these regards could be used to identify lawn care services who make representations and/or who have a trustworthy reputation or record for doing a good job of cleaning up the debris that accumulates when mowing a lawn. This person, in turn, will likely appreciate the reduced effort on their part required to locate such a service that can meaningfully contribute to their desired order.

These teachings can be leveraged in any number of other useful ways. As one example in these regards, various sensors and other inputs can serve to provide automatic updates regarding the events of a given person's day. By one approach, at least some of this information can serve to help inform the development of the aforementioned partiality vectors for such a person. At the same time, such information can help to build a view of a normal day for this particular person. That baseline information can then help detect when this person's day is going experientially awry (i.e., when their desired “order” is off track). Upon detecting such circumstances these teachings will accommodate employing the partiality and product vectors for such a person to help make suggestions (for example, for particular products or services) to help correct the day's order and/or to even effect automatically-engaged actions to correct the person's experienced order.

FIG. 21 provides a more specific illustrative example in these regards. Pursuant to this process 2100 the control circuit 1301 (at block 2101) develops a baseline representation of an experiential routine for a customer. Such a baseline representation can include, for example, a typical daily event timeline for the customer that represents typical locations that the customer visits and/or typical activities in which the customer engages. The timeline can indicate those activities that tend to be scheduled (such as the customer's time at their place of employment or their time spent at their child's sports practices) as well as visits/activities that are normal for the customer though not necessarily undertaken with strict observance to a corresponding schedule (such as visits to local stores, movie theaters, and the homes of nearby friends and relatives).

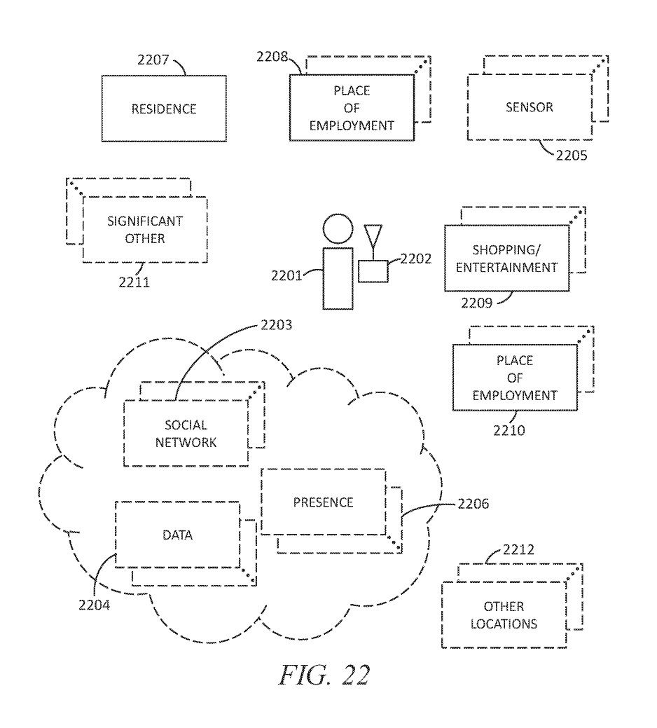

The control circuit 1301 can develop (and also update and maintain) such a baseline representation using any of a variety of information sources 2102. These teachings are not overly sensitive to any particular choices in these regards. A number of useful possibilities in these regards will now be presented, but it will be understood that no particular limitations are intended by the specificity of these examples. These examples are made with reference to both FIGS. 21 and 22.

By one approach the information can include information directly input by the customer 2201 (for example, via the customer's corresponding portable device 2202 such as a so-called smart phone, pad/tablet-styled computer, wrist-worn device, pendant-style device, head-worn device, and/or a device that comprises part of an article of clothing). Such a portable device 2202 can have a user interface by which the customer 2201 enters their information. The portable device 2202 can also have a wireless interface by which the portable device 2202 transmits that information to a corresponding network element by which the control circuit 1301 eventually gains access to either a verbatim version of that customer input or an abridged or otherwise modified form thereof.

By one approach the customer 2201 provides this input in response to questions or other opportunities provided directly by the control circuit 1301 or otherwise by the enterprise that operates and controls the control circuit 1301. As one non-limiting illustrative example in these regards, the customer's direct input may comprise feedback from the customer 2201 as regards a response provided by the control circuit 1301 pursuant to this described process 2100. By another approach the customer 2201 provides this input to another service or in response to another opportunity, with the immediate or eventual intent that the information be shared with the enterprise that operates/controls the control circuit 1301.

By another approach, in lieu of the foregoing or in combination therewith, the information 2102 provided to the control circuit 1301 can include any of a variety of indirect customer inputs. As one example in these regards, the information may comprise social networking postings corresponding to (or made by) the customer 2201 that appear on one or more social networks 2203 frequented by the customer 2201. This can include such things as posted text messages, still images, and videos as well as “likes,” comments, selected emoticons, “friend” and “link” choices, and so forth. As another related example in these regards, the information may reflect web surfing activities corresponding to the customer 2201. For example, the particular websites, pages, articles and so forth that the customer 2201 is or has accessed and/or bookmarked.

As another example, the information 2102 provided to the control circuit 1301 can comprise location information for the customer 2201. Such location information may be sourced by the customer's portable device 2202 when the latter has, for example, location-determining capabilities (such as a global positioning system (GPS) receiver). A customer's location may also be gleaned, in whole or in part, from other information sources including but not limited to surveillance cameras, social networking posts and updates, traffic cameras, mobile analytics data, Wi-Fi and Bluetooth access point registrations, radio-frequency identification (RFID) tag and near-field tag reads, and so forth as may be available and where the customer 2201 may have approved of such usage.

As another example, the information 2102 provided to the control circuit 1301 can comprise scheduling information corresponding to the customer 2201. This scheduling information may be gleaned, for example, from a calendar application maintained and used by the customer 2201 on their portable device 2202. By another approach this scheduling information may be gleaned from a cloud-sourced data repository 2204 that the customer 2201 employs for that purpose. In some cases scheduling information may also be gleaned from the customer's emails, Tweets, and social-networking communications to the extent that the customer 2201 has again approved of such usage. Examples of useful scheduling information include appointments and scheduled events that identify locations and/or activities that correspond to particular identified days and times.

As another example, the information 2102 provided to the control circuit 1301 can comprise purchasing information corresponding to the customer 2201. As one illustrative example in these regards, the customer 2201 may personally submit scans of their retail receipts and/or other identifying information regarding their purchases directly to the control circuit 1301 or another related network entity. The shopping venues, shopping times, and purchased items that are typical for the customer 2201 can all help the control circuit 1301 to develop the corresponding baseline representation of the customer's experiential routine.

As yet another example, the information 2102 provided to the control circuit 1301 can include information provided by any of a wide variety of sensors 2205. By one approach, the relevant sensor may comprise a part of the customer's portable device 2202. Examples in these regards include location and movement sensors, direction of movement sensors, audio sensors, temperature sensors, altitude sensors, device usage sensors, and any of a wide variety of biological sensors (such as pulse sensors, step sensors, and so forth).

In other cases the sensors 2205 may comprise third-party devices that are remotely located with respect to the customer 2201. As one example in these regards, the sensor information may be sourced by a vehicle that corresponds to the customer 2201. Examples of information can include location information, navigation/destination information, information/entertainment settings, number of occupants, and so forth. As another example the sensor 2205 may serve to monitor and track the web surfing activities of the customer 2201.

And as yet another example in these regards, the information 2102 provided to the control circuit 1301 may comprise presence information corresponding to the customer 2201. That presence information can represent a physical presence of the customer (for example, the physical presence of the customer 2201 at a particular store) or can represent a virtual presence of the customer (for example, the virtual presence of the customer 2201 in a multi-player networked video game). By one approach, such presence information might be obtained (on a push or a pull basis as desired) from one or more relevant presence servers 2206 as are known in the art.

In addition to the foregoing, this process 2100 will also accommodate having the control circuit 1301 develop the aforementioned baseline representation using objective demographic information 2103 regarding the customer 2201. Examples of objective demographic information include but are not limited to customer name information, family information, address information, budget information, age information, gender information, and race information.

Using objective demographic information 2103, for example, the control circuit 1301 can select a particular template from a plurality of candidate templates that each comprise a generic baseline representation of an experiential routine for customers who share similar objective demographic information. So configured, the control circuit 1301 can use the template in situations where little other more-specific information regarding the customer is available to nevertheless develop a baseline representation of a likely experiential routine for the customer. In that case, the control circuit 1301 can be configured to use later-received supplemental information that is more specifically regarding the customer to modify/personalize the selected generic baseline representation of an experiential routine for the customer to then use as a non-generic baseline representation going forward from that point.

At block 2104, the control circuit 1301 can detect a deviation from the developed baseline representation and can then respond accordingly. In particular, and as illustrated at optional block 2105, the control circuit 1301 can use the aforementioned plurality of partiality vectors 1307 for this customer 2201 and the vectorized product characterizations 1304 to develop such a response. For example, in response to detecting the aforementioned deviation the control circuit 1301 can identify at least one product to assist the customer with restoring the customer's order consistent with the partiality vectors. Or, as another example, the control circuit 1301 can identify at least one product to assist the customer with realizing an aspiration.

The response can also optionally comprise updating the aforementioned baseline representation of the experiential routine for the customer 2201. For example, it may be determined that the detected deviation in fact represents a new normal event for the customer 2201. When true, the control circuit 1301 can update the baseline representation such that the experiential routine for the customer includes this event.

So configured, and with particular reference to FIG. 22, as a particular customer 2201 goes about their day (moving, for example, amongst and between their residence 2207, their place (or places) of employment 2208, one or more shopping/entertainment venues 2209, any of a variety of child-based venues 2210 (such as schools, extracurricular venues, and so forth), the homes or other locations of significant others 2211 (such as spouses, parents, close relatives, and friends), and any number of other locations 2212) and engages in travels and/or activities that are both routine and non-routine, these teachings permit the control circuit 1301 to identify when deviations to the ordinary occur and to use the aforementioned partiality vectors and vectorized product characterizations to identify useful corresponding responses.

When this person's partiality (or relevant partialities) are based upon a particular aspiration, restoring (or otherwise contributing to) order to their situation could include, for example, identifying the order that would be needed for this person to achieve that aspiration. Upon detecting, (for example, based upon purchases, social media, or other relevant inputs) that this person is aspirating to be a gourmet chef, these teachings can provide for plotting a solution that would begin providing/offering additional products/services that would help this person move along a path of increasing how they order their lives towards being a gourmet chef.

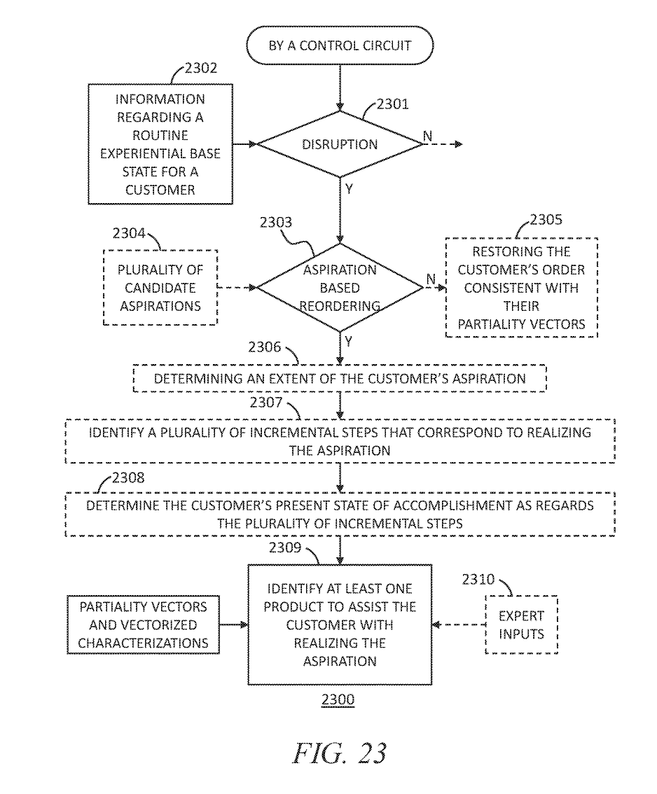

FIG. 23 presents a particular illustrative example in these regards. Pursuant to this process 2300, the control circuit 1301, at block 2301, detects a disruption to the routine experiential base state for a particular customer. Generally speaking, the control circuit 1301 can compare circumstances that pertain to this particular customer with information 2302 regarding a routine experiential base state for a customer (the latter being understood and developed as per the foregoing description). Those referred-to “circumstances” can comprise information representing real-time circumstances for the customer, recent-history circumstances for the customer (such as information regarding the last five minutes, 15 minutes, or one hour for the customer as desired), or even historical information for this customer (such as information regarding the previous day or the previous week for this particular customer).

The specifics of the aforementioned comparison can vary with respect to the details of the information regarding the routine experiential base state for the customer. For example, when the latter only constitutes locations visited by the customer per a particular schedule, then the comparison will likely include detecting when the customer visits other locations and/or when the customer visits previously-noted locations pursuant to a different schedule. As noted above, a baseline representation of an experiential routine for a particular customer can be based upon many different categories of information. Accordingly, the information regarding the routine experiential base state for a customer can be as generalized or as nuanced and rich as may be desired and/or as authorized by the customer.

Upon detecting a disruption to the routine experiential base state for the customer, at block 2303 the control circuit 1301 can determine whether the disruption is one that is occasioned by the customer reordering their life towards realizing an aspiration (as versus a disruption representing a more negative circumstance). By one approach, the control circuit 1301 makes this determination by identifying the particular aspiration that has occasioned the disruption.

This determination, in turn, may be based upon the control circuit 1301 disambiguating amongst a plurality of candidate aspirations 2304 that may all be consistent to a greater or lesser extent with the detected disruption. To put this another way, the control circuit 1301 may assess each of a plurality of aspirations that have previously been associated with this particular customer to determine which aspiration seems most likely to explain the detected disruption. (If desired, these teachings will also accommodate referring to various aspirations that have not been previously associated with this particular customer when looking to determine whether the detected disruption is the result of the customer reordering their life towards realizing a new aspiration.)

When the disruption is not the result of the customer realizing an aspiration, this process 2300 will optionally accommodate, as illustrated at optional block 2305, using the aforementioned partiality vectors 1307 and the vectorized product characterizations 1304 to identify at least one product to assist the customer with restoring their order consistent with their partiality vectors as described elsewhere herein.

When the disruption is the result of an aspiration-based reordering, however, this process 2300 will accommodate an optional determination (illustrated at optional block 2306) regarding an extent of the customer's identified aspiration. Generally speaking, many aspirations can be fairly viewed using a scale of relative achievement. The aspiration of being a good cook, for example, can range from a modest goal of learning to cook homemade nutritious meals using mostly locally-sourced products to attending and graduating from Le Cordon Bleu. Understanding and characterizing such a scale can be accomplished in a variety of ways including with the benefit, guidance, and input of subject-matter experts.

Also if desired, and as illustrated at optional block 2307, this process 2300 will accommodate identifying a plurality of incremental steps that correspond to realizing the identified aspiration. The granularity of these steps can be as general or as nuanced as desired. And again, identifying the incremental steps that can be reliably undertaken to achieve a particular aspiration can be accomplished in a variety of ways including with the benefit, guidance, and input of subjects-matter experts.

When such steps are identified or otherwise available, at optional block 2308 the control circuit 1301 can determine the customer's present state of accomplishment as regards that plurality of incremental steps to thereby identify a particular one of the plurality of incremental steps. This determination may be wholly or partially automated where information regarding activities, skills, and/or accomplishments of the customer are compared against characterizing information for each of the aforementioned incremental steps to identify which step most closely matches the customer's present state of apparent capability in those regards. This determination may also be wholly or partially undertaken through expert assessment, analysis, and assignment. These teachings will also accommodate prompting the customer to provide their own self-assessment in these regards.

At block 2309 this process 2300 provides for identifying at least one product to assist the customer with realizing the identified aspiration. By one approach, the control circuit 1301 can use the partiality vectors 1307 for this customer and appropriate vectorized product characterizations 1304 when identifying such a product. These teachings will also accommodate, if desired, using expert inputs 2310 when identifying such a product.

These teachings are highly practical and will accommodate a variety of modifications and or supplemented activity as desired. As one illustrative example in these regards, when the customer's present state of accomplishment as regards a plurality of incremental steps that correspond to realizing the identified aspiration is available, these teachings will accommodate identifying at least one product to assist the customer with accomplishing a corresponding selected one of the plurality of incremental steps. As one simple example in these regards, when the customer's aspiration is to be a world-class cook and to achieve a next reasonable step in achieving this aspiration they will need additional cookware that they presently lack, the relevant partiality vectors and vectorized product characterizations can serve to identify, at least in part, additional cookware that is not only consistent with achieving the customer's aspiration but that is also most consistent with their own partialities.

Such a product, once identified, can be offered to the customer using any of a variety of approaches. For example, if desired, the identified product can be provided without cost to the customer. Such an approach can serve, for example, to test the extent of the customer's aspiration (by noting, for example, the customer's follow-on behavior, such as whether the customer returns the product without any further related activity, whether the customer keeps the product (with or without a corresponding payment by the customer depending upon the arrangement), or whether the customer returns the product but makes a subsequent related but substitute purchase that is consistent with the aspiration but which may shed further light on the extent of the customer's aspiration and/or the customer's own level-of-accomplishment in those regards.

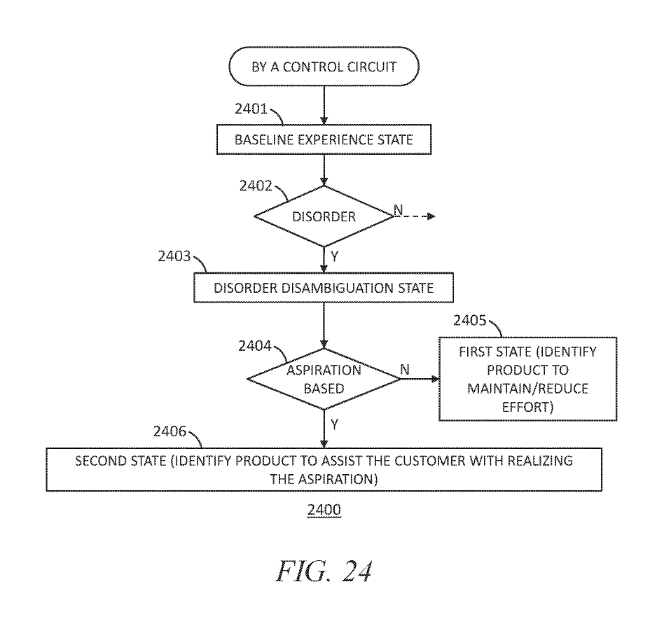

As noted previously, these teachings will accommodate configuring the control circuit 1301 as a state engine to carry out some or all of the activities described herein. FIG. 24 provides an illustrative example in these regards in the context of servicing a customer's aspirations per the foregoing description.

Per this process 2400, the control circuit 1301, configured as a state engine, has a customer baseline experience state 2401. This state can reflect and constitute the aforementioned baseline representation of an experiential routine for a particular customer.

At block 2402 the state engine, upon detecting disorder with respect to the customer's baseline experience state, transitions to a disorder disambiguation state 2403. This state serves to determine (at block 2404) when the detected disorder comprises a disruption occasion by the customer when reordering their life towards realizing an aspiration, or conversely, when the disruption is otherwise occasioned. When the disruption is not owing to an aspiration, the state engine transitions to a first state 2405 pursuant to which the control circuit 1301 processes the customer's partiality vectors 1307 and vectorized product characterizations 1304 to identify a product to at least maintain or to reduce the customer's corresponding effort.

When the disorder is the result of an aspiration, however, the state engine transitions to a second state 2406 to process partiality vectors 1307 and vectorized product characterizations 1304 to identify at least one product to assist the customer with realizing the aspiration (for example, as per the description provided above).

By one approach, these teachings will accommodate presenting the consumer with choices that correspond to solutions that are intended and serve to test the true conviction of the consumer as to a particular aspiration. The reaction of the consumer to such test solutions can then further inform the system as to the confidence level that this consumer holds a particular aspiration with some genuine conviction. In particular, and as one example, that confidence can in turn influence the degree and/or direction of the consumer value vector(s) in the direction of that confirmed aspiration.

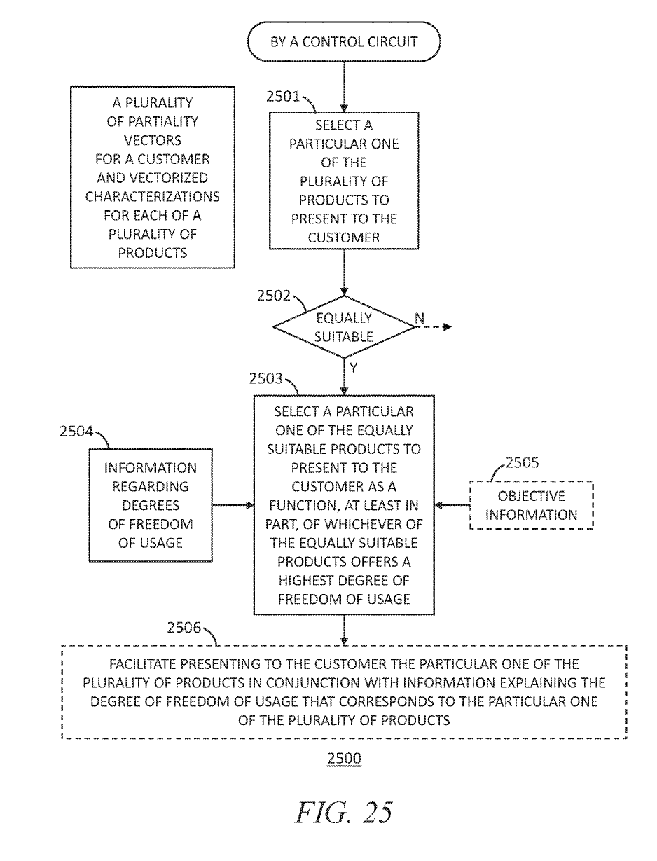

It is possible that more than one product will appear equally suitable to present to a customer when assessing various products as a function of the customer's partiality vectors 1307 and vectorized product characterizations 1304 per these teachings. FIG. 25 presents a process 2500 to address such an outcome.

Per this process 2500 the control circuit 1301 selects (at block 2501), or perhaps more accurately, attempts to select a particular one of a plurality of products to present to a customer as a function of a plurality of partiality vectors 1307 for the customer and vectorized product characterizations 1304 for each of a plurality of products. Such an activity can be in support of, for example, selecting a particular product to offer to a customer for purchase or for selecting a particular sample of a product to deliver to the customer without cost to the customer (and possibly to ship to the customer without the customer having ordered this particular product). Another example in these regards would be to select a product (or a sample of a product) to deliver to the customer without the customer having first ordered the product along with an offer or other opportunity to make future shipments of this product to the customer on some regular automated basis subject to a corresponding charge.

At decision block 2502 the control circuit 1301 determines when the foregoing activity yields a plurality of products that are equally suitable in view of the aforementioned partiality vectors 1307 (as well as any applicable vectorized product characterizations 1304). By one approach this inquiry will identify multiple products that are exactly equally suitable by whatever metric or metrics are appropriately in use for the particular partialities and/or product characterizations in play. By another approach this inquiry can serve to identify multiple products that may not be exactly equally suitable but which are within some predetermined distance from one another as again measured by whatever metric or metrics are appropriately in use.

In the absence of detecting that there are a plurality of products that are equally suitable, this process 2500 can accommodate any of a variety of responses. Examples of responses can include transitioning to other activities and/or states pending a need to select another product to present to the customer per this process.

When there are a plurality of equally suitable products, at block 2503 the control circuit 1301 selects a particular one of the equally suitable products to present to the customer as a function, at least in part, of whichever of the equally suitable products offers a highest degree of freedom of usage. The control circuit 1301 can draw upon information 2504 regarding degrees of freedom of usage as stored, for example, at a corresponding memory 1302. Such information may be available for only some of the plurality of products, or at least a majority of the plurality of products, or all of the plurality of products as desired. By another approach, in lieu of the foregoing or in combination therewith, the control circuit 1301 can be further configured to itself determine, on an as-needed basis, the degree of freedom of usage for particular ones of the products that were found to be equally suitable.

Generally speaking, consideration of these degrees of freedom of usage can include consideration of a future value proposition and/or a past value proposition as desired. By one approach each degree of freedom of usage can correspond to a different modality of usage. As a simple illustrative example in these regards, a product such as vinegar has a first modality of use as an edible commodity, a second modality of use as a cleaning agent for laundry, and a third modality of use as a household cleaning agent. Conversely, vegetables oil has a modality of use as an edible commodity but cannot also be used as a cleaning agent for laundry or as a household cleaning agent. In a situation where both vinegar and vegetable oil appear to be equally suitable for presentation to a customer, the control circuit 1301 can select the vinegar to present to the customer because the vinegar offers a higher degree of freedom of usage as compared to the vegetable oil.

In such a case it will typically be useful to filter or otherwise assess such degrees of freedom with respect to the customer's own partiality vectors; in particular, to filter/assess a product with greater emphasis/weight being given to particular degrees of freedom that more strongly align with one or more of the customer's partiality vectors as compared to degrees of freedom that do not align as strongly with the customer's partiality vectors (or which, in fact, are misaligned with the customer's partiality vectors). As a simple illustrative example in these regards, a given liquid soap may have three degrees of freedom in that the soap may be useful for washing dishes, shampooing, and personal shaving, and the shaving modality may in particular align with the customer's partialities, but the entirety of the customer's partialities may align best with shaving soaps that also moisturize. In that case this particular product may be less preferable as compared to other options that better align overall with the customer's partialities.

As represented at optional block 2505, the foregoing consideration can also optionally take into account one or more items of objective information. This can include objective information regarding the customer and/or objective logistical information regarding providing particular products to the customer. Examples of objective information include but are not limited to location information (regarding the customer and/or the product itself), budget information for the customer, age information for the customer, gender information for the customer, product availability (such as immediate or near-term availability to be shipped to the customer), shipping limitations that apply to the product and/or the location of the customer, and any of a variety of applicable legal limitations that apply with respect to the customer, the customer's location, the product itself, and/or with respect to transport and/or delivery of the product, to note but a few examples in these regards.

Having selected a particular one of the equally suitable products to present to the customer, at optional block 2506 the control circuit 1301 can then facilitate presenting to the customer the selected particular one of the plurality of products in conjunction with information that explains the degree of freedom of usage that corresponds to the selected product. By this approach the customer can be specifically informed about, for example, various modalities of usage that apply with respect to the identified product to thereby better ensure that the customer is fully informed and cognizant of such benefits.

Pursuant to these teachings, a control circuit has access to information including a plurality of partiality vectors for a customer and vectorized product characterizations for each of a plurality of products. The control circuit is also configured to develop a baseline representation of an experiential routine for the customer and to then use the aforementioned information to develop responses to detected deviations from that baseline representation.

These teachings will accommodate developing that baseline representation using any of a variety of information sources. Examples include but are not limited to information directly input by the customer (including customer-provided feedback offered in response to being provided with a product), social networking postings, customer-related location information, customer-related scheduling information, presence information regarding the customer (including information regarding a physical presence of the customer as well as a virtual presence of the customer), web-surfing activities corresponding to the customer, and purchasing information corresponding to the customer. These teachings will also accommodate using information from any of a variety of sensors including sensors that are integral to a portable device that is personal to the customer as well as sensors that are remotely located with respect to the customer.

The control circuit can be further configured to identify at least one product to assist the customer with restoring the customer's order consistent with their partiality vectors and/or to identify at least one product to assist the customer with realizing an aspiration.

All the above approaches are informed by the constraints the value space places on individuals so that they follow the path of least perceived effort to order their lives to accord with their values which results in partialities. People generally order their lives consistently unless and until their belief system is acted upon by the force of a new trusted value proposition. The present teachings are uniquely able to identify, quantify, and leverage the many aspects that collectively inform and define such belief systems.

An person's preferences can emerge from a perception that a product or service removes effort to order their lives according to their values. The present teachings acknowledge and even leverage that it is possible to have a preference for a product or service that a person has never heard of before in that, as soon as the person perceives how it will make their lives easier they will prefer it. Most predictive analytics that use preferences are trying to predict a decision the customer is likely to make. The present teachings are directed to calculating a reduced effort solution that can/will inherently and innately be something to which the person is partial.

Understanding these partialities relative to particular degrees of entropy can be helpful to presenting consumers with opportunities to purchase one or more commercial objects (i.e. products and services) in a manner that increases the probability of the targeted consumer(s) purchasing one or more of the commercial objects. In other words, understanding these partialities can encourage (i.e., increase the probability of) consumer participation in the purchase opportunity, which may increase the satisfaction that targeted customers experience when participating in the purchase opportunities, increase corporate goodwill by enhancing the customer service experiences of targeted consumers, increase sales volumes of one or more commercial objects by presenting purchase opportunities for such commercial objects to targeted consumers, increase supplier satisfaction due to an increased sales volume of their products, and/or other such commercial bases. Purchase opportunities, for example, can be commercial solicitations formed in a manner to encourage consumers to purchase one or more commercial objects. Purchase opportunities can be any proposal to sell commercial objects, dissemination of information for the purpose of facilitating the sale of commercial objects (e.g., advertisements, coupons, and similar commercial notifications), similar commercial activities, or a combination of two or more thereof, in accordance with some embodiments.

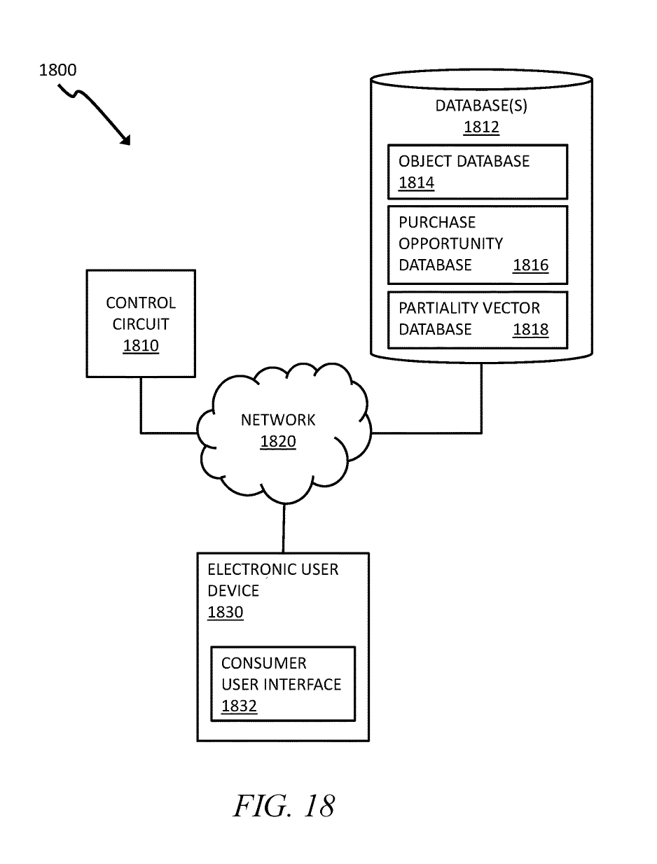

So configured, purchase opportunities can be personalized using partiality vectors for consumers and commercial objects that are derived as discussed above. By one approach, for example, that information can serve to identify opportunities to increase the probability of the targeted consumer(s) participating in the purchase opportunities. In some embodiments, the system can identify one or more replacement products with one or more products that more closely correspond to a customer's partiality vector than one or more initial products. FIG. 18 illustrates a simplified block diagram of a system 1800 to assess purchase opportunities, in accordance with some embodiments. System 1800 can comprise one or more electronic user devices 1830, databases 1812, and control circuits 1810 configured to communicate over a computer and/or one or more communication networks (“networks”) 1820.

Networks 1820 can be, for example, a local area network (LAN), a wide area network (WAN) such as the Internet, or a combination of the two, and includes wired, wireless, or fiber optic connections. In certain embodiments, networks 1820 may be networks 1310 (discussed above) or may be included therein and as such the control circuits 1810 may be communicatively coupled to memories 1303, 1306, or both. In general, network 1820 can be any combination of connections and protocols that can support communications between the control circuits 1810, electronic user devices 1830, and databases 1812, in accordance with some embodiments.

The electronic user devices 1830 can each be a desktop computer, a laptop computer, a thin client, a server, a cluster computer, a smart TV, an in-vehicle computing device, a wearable computing device, a mobile device (e.g., smart phones, phablets, tablets, and similar devices) or similar devices, among others. Electronic user devices 1830 can include one or more input/output devices that facilitate consumer interaction with the device (e.g., displays, speakers, microphones, keyboards, mice, touch screens, joysticks, dongles, pointing devices, game pads, cameras, gesture-based input devices, and similar I/O devices). As illustrated, the consumer user interfaces 1832, which may be operated at one or more electronic user devices 1830, may be communicatively coupled over one or more distributed communication networks such as network 1820. By one approach, an electronic user device 1830 may be associated with one or more consumers, customers, shoppers, pedestrians, similar persons of interest, or a combination of two or more thereof. Additionally, or alternatively, one or more electronic user devices 1830 may be associated with, affixed to, and/or positioned proximate to mobile retail platforms (e.g., commercial lockers, food vehicles, food carts, commercial object distribution devices/vehicles, pop-up store fronts, kiosks, and similar retail platforms), billboards, similar commercial entities, or a combination of two or more thereof.

Consumer user interface 1832 includes software that one or more consumers can use to participate in purchase opportunities, in accordance with some embodiments. Consumer user interface 1832, for example, can include one or more graphical icons, visual indicators, and/or command-line indicators that allow consumers to interact with the consumer user interface 1832. Consumers can interact with the consumer user interface 1832 via manipulation of the electronic user device 1830, such as, for example, by manipulating graphical icons and/or visual indicators displayed on the electronic user device 1830. Additionally, or alternatively, consumers can interact with the consumer user interfaces 1832 by issuing one or more commands into the command-line interfaces.

In certain embodiments, the partiality vector database 1818 can include the vectorized characterizations for commercial objects (i.e., commercial object partiality vectors) and consumers (i.e., consumer partiality vectors) included in memories 1303 and 1306, respectively. As discussed above, partiality vectors can, for example, be based on one or more affinities, aspirations, preferences, similar evaluative judgments, or a combination of two or more thereof. For example, partiality vector database(s) 1818 can receive one or more partiality vectors from control circuit 1201. In other embodiments, the partiality vector database(s) 1818 can be stored in memories 2014, partiality vector database 1818, customer electronic user devices, similar devices, or a combination of two or more thereof to form distributed database of partiality vectors. By one approach, the one or more control circuits 1810 can be configured (for example, by using corresponding programming as will be well understood by those skilled in the art) to carry out one or more of the steps, actions, and/or functions described herein. As such, the partiality vector database(s) 1818 can comprise one or more partiality vectors generated by the control circuits 1810 as described above. One or more customer electronic user devices may also be configured to carry out one or more of the steps, actions, and/or functions described herein. Additionally or alternatively, the one or more control circuits 1810 and the one or more customer electronic user devices can form a distributed processing system configured to carry out one or more of the steps, actions, and/or functions described herein.

Again, partiality vectors have both direction and magnitude. In certain embodiments, purchase opportunities are assessed to identify opportunities to increase the probability that targeted consumers participate in the purchase opportunities. By one approach, such opportunities can be identified by ascertaining the one or more commercial objects having one or more partiality vectors that are aligned (i.e., have congruity) with the one or more partiality vectors of the targeted consumers. Alignment values typically have a direct relationship with congruity. For example, the dot product of two partiality vectors can be defined by the following equation:

OPV·CPV=|OPV| cos θ·|CPV|

which corresponds to a scalar value defining the extent to which the commercial object partiality vector (OPV) coincides with the direction of the consumer partiality vector (CPV), and wherein θ· is the angle between OPV and CPV.

Thusly defined, the resulting scalar values are positive when the CPV and OPV pair are at least partially directed in the same direction. The scalar values are negative when the CPV and OPV pair are not at least partially directed in the same direction. Scalar values are neither positive nor negative (i.e., are equal to zero) when the CPV and OPV pair are orthogonal to each other. By one optional approach, an alignment value can reflect the dot product of a consumer PV and the related commercial object PV as defined above. Consumers and commercial objects may each be defined using one or more CPVs and OPVs, respectively. In embodiments where consumers and commercial objects are defined via one or more CPVs and OPVs, respectively, alignment values may be based on one or more dot products. Alignment values, in certain embodiments, may be based on the sum, average, difference, product, quotient, similar mathematical calculations, or a combination of two or more mathematical calculations of two or more differing dot product scalar values.

As discussed above, commercial objects can be described using one or more characteristics (e.g., freshness, sourcing, material type, production type, ecological impact, similar characteristics, or a combination of two or more thereof). For example, a consumer may be characterized by CPV₁ and CPV₂ and a commercial object characterized by OPV₁ and OPV₂. Here, CPV₁ and OPV₁ can define a related characteristic (e.g., freshness) and CPV₂ and OPV₂ can define another related characteristic (e.g., sourcing). A first dot product (DP₁) can be derived for CPV₁ and OPV₁ and a second dot product (DP₂) can be derived for CPV₂ and OPV₂. The resultant alignment value can be defined as DP₁, DP₂, the average of DP₁ and DP₂, or the sum of DP₁ and DP₂. Although alignment values based on a single dot product can be used, where two or more partiality vectors are available, alignment values that reflect the sum or average of dot products may provide the granular details that facilitate characterizing the alignment that supports identifying opportunities to increase the probability that targeted consumers participate in the purchase opportunities. Other embodiments apply alignment rules from one or more rules databases and in part consider each alignment value relative to a corresponding alignment threshold before considering the vector. Similarly, a threshold number of alignment values having corresponding threshold values may have to be identified in determining whether there is sufficient alignment to indicate a determined probability that a customer will participate in a purchase opportunity and/or change future purchase habits.

For example, for purchase opportunities that include a particular commercial object (e.g., a gallon container of 2% milk) or type of product, the one or more control circuits 1810 may access object database 1814 and identify one or more potential replacement commercial objects included therein that have a threshold relationship to the commercial object (e.g., are similar in type to the commercial object) of the purchase opportunity (e.g., whole milk, almond milk, rice milk, organic 2% milk, unpasteurized milk, and other types/manufactures of milk). In some embodiments, potential replacement commercial objects are identified in response to one or more alignment values (determined between product partiality vectors associated with the particular commercial and the customer's partiality vectors) that are less than one or more corresponding thresholds, a determination of a negative alignment of one or more corresponding product and customer partiality vectors, an attempt to identify a product that may more likely be desired by the customer, and/or other such conditions. As one simple example, a meal plan may propose grilled chicken as a main course accompanied by broccoli, a tossed green salad, sliced peaches, and dinner rolls. Through an evaluation of partiality vectors, a negative alignment value with the grilled chicken (e.g., because the customer is a vegetarian) may be identified. One or more potential replacement commercial objects (e.g., a plant-based meat substitute) can be identified that can be presented to the customer in place of the original commercial object (i.e., the chicken) as at least part of a purchase opportunity to increase the probability of that the consumer will participate in the purchase opportunity.

For each potential replacement commercial object identified in object database 1814 (i.e., based on one or more applied rules, each particular type of milk having the appropriate volume), the control circuit 1810 accesses PVs associated with that potential replacement commercial object and PVs associated with a consumer. Based on one or more rules, the control circuit ascertains both the one or more PVs associated with that particular commercial object and the one or more PVs associated with the consumer identified in the purchase opportunity and generates one or more corresponding alignment values (as discussed above). The control circuits 1810 may then select for presentation to the consumer the one or more replacement commercial objects, for example, having the highest generated alignment values, which may correspond to the one or more replacement commercial objects included in object database 1814 that are determined to have PVs that are aligned with the PVs of the consumer.

Similarly, one or more replacement commercial objects may be identified based on a product providing the most number of alignment values that are greater than a threshold; may be identified based on one or more products having a highest pair of alignment values; may be identified based on one or more products having at least a first alignment value greater than a first threshold and a second alignment value greater than a second threshold; may be identified based on one or more products having an alignment value within a standard deviation from a median value of a set of product partiality vectors; or other such alignment value relationships based on one or more alignment rules. In certain embodiments, one or more replacement commercial objects share can share a threshold amount of characteristics with one or more commercial objects. Some partiality vectors may further have priorities associated with them, and these priorities may indicate which corresponding alignment values are considered over other alignment values. In some embodiments, the control circuit further limits replacement products to those products that establish an alignment value that is greater than an alignment value between the original product and the customer (e.g., replacement alignment value is greater than an alignment value of the partiality vector of the original product and the customer).

As discussed above, purchase opportunities are assessed to identify opportunities to include one or more replacement products in the purchase opportunities that may be likely to increase the probability that targeted consumers participate in the purchase opportunities. For example, one or more replacement products can be identified for some or all purchase opportunities generated, purchase opportunities that have a determined consumer participation rate below a threshold amount, purchase opportunities targeting a select group of consumers, other similar commercial bases, or a combination of two or more thereof. For example, a purchase opportunity for a meal plan may include a red wine for the beverage selection. When presented to consumers that have one or more partiality vectors aligned with sobriety (e.g., partiality vectors that reflect above average religious activity, consumption of certain prescription medications, being underage, or similar partialities), such partiality vectors have a poor alignment (e.g., opposite alignment or an alignment below a threshold amount) with red wine.

The purchase opportunity for the meal plan should therefore be changed to include one or more beverages that each have one or more partiality vectors that have an increased alignment with sobriety relative to the consumer (e.g., sparkling water, iced tea, a juice, and/or other non-alcoholic beverage) compared to red wine. The aforementioned threshold amount by which replacement products are identified can be set and selected as desired. By one approach, the threshold is static such that the same threshold is employed regardless of the circumstances. By another approach, the threshold is dynamic and can vary with such things as the quantity of PVs with which alignment values are based and/or the amount of data used to generate the PVs and/or the duration of time over which the data used to generate the PVs are available. In some embodiments, replacement products can be characterized as having alignment values that have a statistically significant increase over the original products. The aforementioned “statistically significant” standard can be selected and/or adjusted to suit the needs of a given application setting. The scale or units by which this measurement can be assessed can be any known, relevant scale/unit including, but not limited to, scales such as standard deviations, cumulative percentages, percentile equivalents, Z-scores, T-scores, standard nines, and percentages in standard nines.

By one approach, the consumer identified in some purchase opportunities may correspond to a plurality of persons located at or associated with a particular non-retail event (e.g., sporting event, musical concert/event, political event, and/or similar non-retail events) and/or non-retail locations (e.g., residential, commercial, collegiate, and/or similar non-retail locations). It is of course possible that partiality vectors may not be available yet for each person due to a lack of sufficient specific source information from or regarding that particular person. In this case it may nevertheless be possible to use one or more partiality vector templates that generally represent certain groups of people that fairly include a number (e.g., a threshold amount) of persons included in the plurality of persons. For example, if the person's gender, age, academic status/achievements, and/or postal code are known it may be useful to utilize a template that includes one or more partiality vectors that represent some statistical average or norm of other persons matching those (or a threshold amount) same characterizing parameters.

Multiple individuals can be identified that have a threshold relationship with one or more characterizing parameters. In some embodiments, partiality vectors for each of those individuals can be accessed and used to determine template partiality vectors. For example, a first template partiality vector may be an average of the multiple first partiality vectors associated with two or more of the multiple individuals. The template partiality vectors may be determined as a median vector, a range of vectors (e.g., within a standard deviation), an average once one or more outliers are removed from the calculation, and/or other such considerations. Further, other factors may be taken into account, such as one or more scalers, priorities of individuals, distribution of individual partiality vectors, and/or other such factors.

Of course, while it may be useful to at least begin to employ these teachings with certain plurality or persons by using one or more such templates, these teachings will also accommodate modifying (perhaps significantly and perhaps quickly) such a starting point over time as part of developing a more personal set of partiality vectors that are specific to the plurality of persons. For example, one or more such templates can be updated, amended, re-calculated when additional information specific to the plurality of person is received (e.g., in PV database 1818, memory 1303, memory 1306, memory 2014, and/or another memory module communicatively coupled to network 1820). A variety of templates could be developed based, for example, on professions, academic pursuits and achievements, nationalities and/or ethnicities, characterizing hobbies, and the like. By one approach, such templates may be stored in PV database 1818, memory 1306, memory 1202, memory 2014, and/or another memory module communicatively coupled to network 1820.

Such template PVs can be utilized by the control circuits 1810 to assess purchase opportunities for non-traditional retail platforms (e.g., commercial lockers, vending machines, mobile retail platforms equipped for selling commercial objects, kiosks, commercial stands or booths, pop-up store fronts, food trucks, and/or similar non-traditional retail platforms). Such commercial platforms generally store one or more types of commercial objects for sale (e.g., perishable and/or non-perishable food items, apparel items, consumables, and similar types of commercial objects) and can be temporarily or permanently established at predetermined locations (e.g., residential, commercial, collegiate, non-retail spaces, similar locations, or a combination of two or more thereof) frequented by persons of one or more particular demographics. For example, a retail platform (e.g., a commercial locker) may be located on or near a university campus attended by students of one or more particular demographics (e.g., age, gender, income, and/or similar characterizing parameters).

One or more PV templates each having one or more partiality vectors that represent some statistical average or norm of other persons matching those same characterizing parameters may be used to assess the one or more purchase opportunities used to stock commercial objects in the commercial locker. In one approach, a non-traditional retail platform, such as a kiosk located in a non-retail space (e.g., a subway platform), can be frequented by one or more persons of one or more particular demographics at particular time of the day and/or week. For example, working professionals (e.g., career-focused persons aged 25-55) may correspond to the majority (i.e., at least 51%) of those frequenting the non-retail space between traditional working hours (e.g., 9 AM to 5 PM) on a particular weekday, while socially inclined individuals (e.g., party goers, celebrators, merrymakers, revelers, roisterers, and/or similar individuals) may correspond to the majority of persons frequenting the kiosk during nights and/or weekends. Arguably, these two agglomerations of consumers may each correspond to a unique set of characterizing parameters. Hence, each unique set of characterizing parameters may be represented by one or more PV templates that generally represent certain groups of people that fairly include that particular agglomeration. The one or more PV templates may be used to assess one or more purchase opportunities used to stock the kiosk on, for example, a time-specific basis.

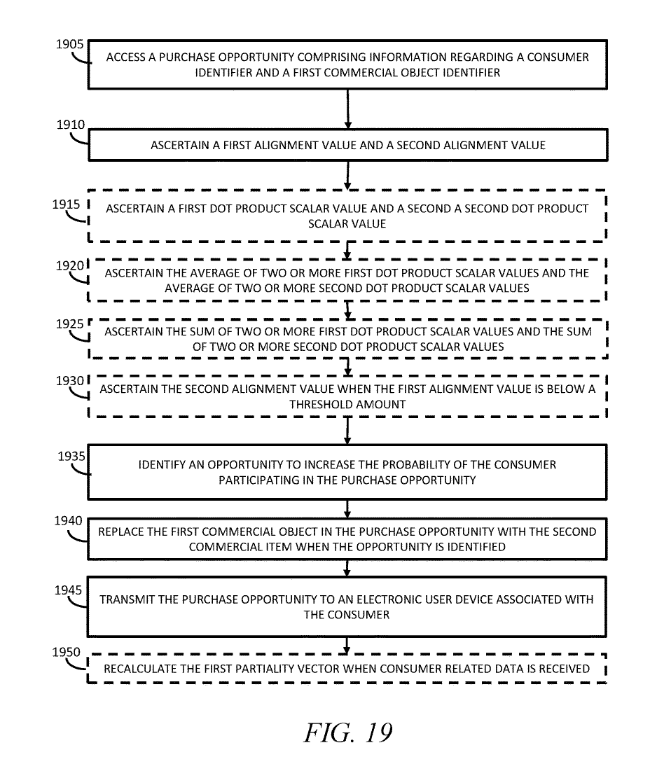

In particular, FIG. 19 illustrated the operational steps of assessing purchase opportunities corresponding to the sale of commercial objects, in accordance with some embodiments. A purchase opportunity stored in the purchase opportunity database 1816 as well as associated information can be accessed at block 1905 by the control circuits 1810. For example, purchase opportunity database 1816 may store therein one or more lists of one or more purchase opportunities. Control circuits 1810, for example, can access purchase opportunities included in the one or more lists (e.g., on a first-in-first-out, a last-in-last-out basis, filtered based on one or more parameters, etc.). Purchase opportunities typically each include information that corresponds to a targeted consumer (e.g., via a unique consumer identifier) and one or more first commercial objects (e.g., each via a unique commercial object identifier). Each consumer identifier is typically associated with one or more consumer PVs (e.g., stored in the PV database 1818), where such PVs characterize the particular consumer as discussed above.

First commercial object identifiers are each exclusively associated with a respective particular first commercial object (e.g., listed in object database 1814) of the purchase opportunity and typically undergo assessment prior to presentation to the targeted consumer, according to one or more of the processes described herein. First commercial object identifiers are also each exclusively associated with one or more commercial object PVs, which characterize the particular commercial object and are used by the control circuits 1810 to assess the associated commercial object.

At block 1910, the control circuits 1810 ascertain a first alignment value and one or more second alignment values for each commercial object listed in the purchase opportunity, in accordance with some embodiments. As used herein, first alignment values correspond to an alignment relationship between one or more PVs of the targeted consumer (“consumer PVs”) and one or more related PVs of a particular commercial object listed in the purchase opportunity (“object PVs”). As such, first alignment values reflect the extent to which the one or more commercial object originally defined in the unassessed purchase opportunity are aligned with the targeted consumer. In certain embodiments, one or more replacement commercial objects can be identified for each original commercial object having a first alignment value that is below a corresponding threshold amount. Such a threshold amount may reflect a probability of the targeted consumer participating in a purchasing opportunity for that particular commercial object.

Second alignment values can correspond to an alignment relationship between one or more consumer PVs and one or more related PVs of a particular replacement object (“replacement object PVs”). In certain embodiments, object database 1814 can include one or more lists of one or more unique commercial object identifiers each associated with a particular commercial object identified in a purchase opportunity or a replacement commercial object, wherein the list associates each commercial object identifier with one or more identifying characteristics (e.g., name, manufacturer, industry, quantity, composition type, category, similar identifying characteristics, or a combination of two or more thereof). By one approach commercial objects that share a threshold amount (e.g., one, two, three, four, ect.) of identifying characteristics may be assumed to be related. As such, second alignment values correspond to the extent to which the one or more PVs of a related commercial object (“third”) are aligned with the related one or more PVs of the targeted consumer.

In some embodiments, at block 1915, the control circuits 1810 can optionally use the dot product of a consumer PV and an object PV (“first dot product scalar value”) to ascertain a first alignment value and the dot product of the consumer PV and a related replacement object PV (“second dot product scalar value”) to ascertain a second alignment value as discussed above. By one approach, at block 1920, the control circuits 1810 can optionally use the average of two or more first dot product scalar values to ascertain the first alignment value and the average of two or more second dot product scalar values to ascertain the second alignment value. In certain embodiments, at block 1925, the control circuits 1810 can optionally use the sum of two or more first dot product scalar values to ascertain the first alignment value and the sum of two or more second dot product scalar values to ascertain the second alignment value. In some aspects, at block 1930, the control circuits 1810 can optionally ascertain the second alignment value when the first alignment value is determined to be below a threshold amount. For example, the threshold amount may correspond to a value that is less than zero or a similar value that denotes an alignment that corresponds to a decrease probability that the targeted consumer will participate in the purchase opportunity.

At block 1935, the control circuits 1810 utilizes the first alignment value and the one or more second alignment values to identify one or more opportunities to increase the probability that the targeted consumer will participate in the purchase opportunity. Such opportunities can arise when a second alignment value is determined to be greater than the first alignment value. To identify such an opportunity, for example, the first alignment value is compared to each second alignment value associated with one or more replacement commercial objects to ascertain which second alignment values are greater (i.e. more closely aligned) than the first alignment value by at least a threshold amount (e.g., an amount that conveys statistical significance). Such a threshold amount can be unique to a particular commercial object(s); apply to all commercial objects; determined over time based on previous object replacements and subsequent feedback (e.g., detected subsequent purchases, responses to surveys, etc.); generated by the control circuits 1810, central control circuit, or manufacturer; or a combination of two or more thereof.

At block 1940, the control circuits 1810 can replace one or more particular commercial objects in the purchase opportunity with one or more of the more closely aligned replacement commercial objects (i.e., which reflect an identified opportunity). Replacement commercial objects can be chosen using a plurality of selection criteria, for example, highest value, top 25%, top 50%, or another dot product scalar value criteria. The steps disclosed in blocks 1910-1940 can be repeated for each commercial object listed in the purchase opportunity. At block 1945, when the one or more commercial objects listed in the purchase opportunity are assess as disclosed above, the control circuits 1810 can associate the commercial object identifiers of the selected replacement commercial object with the purchase opportunity and cause the purchase opportunity to be presented to the customer (e.g., electronically transmitted to the electronic user device 1830 for subsequent rendering on the consumer user interface 1832, presented though a coupon, presented through a demonstration, displayed through an in-store display system, and/or other such methods). By one approach, at block 1950, the control circuits 1810 or one or more central control circuits can optionally recalculate one or more consumer PVs when new, previously unknown, recently discovered/introduced consumer-related information (e.g., new social media posting, blog entry, subsequent purchase information, or similar up to date information) is received, for example, by databases 1812 or other databases communicatively coupled to network 1820. For example, the consumer-related information can comprise one or more values, a preferences, aspirations, affinities, similar evaluative judgments, or a combination of two or more thereof.

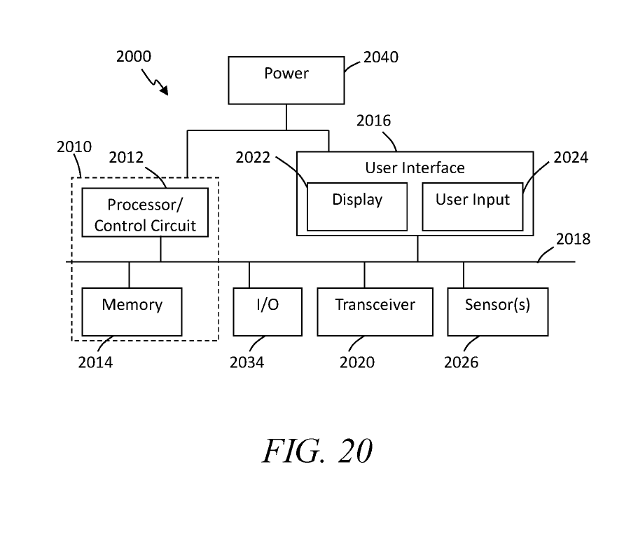

Further, the circuits, circuitry, systems, devices, processes, methods, techniques, functionality, services, servers, sources and the like described herein may be utilized, implemented and/or run on many different types of devices and/or systems. FIG. 20 illustrates an exemplary system 2000 that may be used to implement some or all of the computing device or the control circuit 1810, the electronic user device 1830, one or more other control circuits and/or processing systems of the control circuit 1810, one or more remote central control systems, and/or other such components, circuitry, functionality and/or devices. However, the use of the system 2000 or any portion thereof is certainly not required.

By way of example, the system 2000 may comprise a control circuit or processor module 2012, memory 2014, and one or more communication links, paths, buses or the like 2018. Some embodiments may include one or more user interfaces 2016, and/or one or more internal and/or external power sources or supplies 2040. The control circuit 2012 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 2012 can be part of control circuitry and/or a control system 2010, which may be implemented through one or more processors with access to one or more memory 2014 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 2000 may be used to implement one or more of the above or below, or parts of, components, circuits, systems, processes and the like.

The user interface 2016 can allow a user to interact with the system 2000 and receive information through the system. In some instances, the user interface 2016 includes a display 2022 and/or one or more user inputs 2024, such as buttons, touch screen, track ball, keyboard, mouse, etc., which can be part of or wired or wirelessly coupled with the system 2000. Typically, the system 2000 further includes one or more communication interfaces, ports, transceivers 2020 and the like allowing the system 2000 to communicate over a communication bus, a distributed computer and/or communication network 1820 (e.g., a local area network (LAN), the Internet, wide area network (WAN), etc.), communication link 2018, other networks or communication channels with other devices and/or other such communications or combination of two or more of such communication methods. Further the transceiver 2020 can be configured for wired, wireless, optical, fiber optical cable, satellite, or other such communication configurations or combinations of two or more of such communications. Some embodiments include one or more input/output (I/O) ports 2034 that allow one or more devices to couple with the system 2000. The I/O ports can be substantially any relevant port or combinations of ports, such as but not limited to USB, Ethernet, or other such ports. The I/O interface 2034 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 2026 to provide information to the system and/or sensor information that is communicated to another component, such as the central control system, a delivery vehicle, etc. The sensors can include substantially any relevant sensor, such as distance measurement sensors (e.g., optical units, sound/ultrasound units, etc.), cameras, motion sensors, inertial sensors, accelerometers, impact sensors, pressure sensors, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 2000 comprises an example of a control and/or processor-based system with the control circuit 2012. Again, the control circuit 2012 can be implemented through one or more processors, controllers, central processing units, logic, software and the like. Further, in some implementations the control circuit 2012 may provide multiprocessor functionality.

The memory 2014, which can be accessed by the control circuit 2012, typically includes one or more processor readable and/or computer readable media accessed by at least the control circuit 2012, and can include volatile and/or nonvolatile media, such as RAM, ROM, EEPROM, flash memory and/or other memory technology. Further, the memory 2014 is shown as internal to the control system 2010; however, the memory 2014 can be internal, external or a combination of internal and external memory. Similarly, some or all of the memory 2014 can be internal, external or a combination of internal and external memory of the control circuit 2012. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 1820. The memory 2014 can store code, software, executables, scripts, data, content, lists, programming, programs, log or history data, user information, customer information, product information, and the like. While FIG. 20 illustrates the various components being coupled together via a bus, it is understood that the various components may actually be coupled to the control circuit and/or one or more other components directly.

In some embodiments, systems are provided to assess purchase opportunities corresponding to the sale of commercial objects. The system may also include a database and a communication transceiver each communicatively coupled to the control circuit. The database having a plurality of partiality vectors each associated with either a commercial object or a consumer. The control circuit generally accesses a purchase opportunity having information regarding both a consumer identifier that is exclusively associated with a consumer and one or more commercial object identifiers each exclusively associated with a commercial object. The consumer identifier is typically associated with one or more consumer partiality vectors (“first PVs”). Each commercial object identifier can be associated with one or more commercial object partiality vectors (“second PVs”).

For each commercial object identifier identified by the purchase opportunity, the control circuit can determine a first alignment value and a second alignment value. By one approach, the first alignment value corresponds to an alignment relationship between the one or more first PVs and the one or more second PVs. Typically, the second alignment corresponds to an alignment relationship between the one or more first PVs and the one or more partiality vector for a replacement commercial object (“third PVs”). The control circuit can identify an opportunity to increase the probability of the consumer participating in the purchase opportunity when the second alignment value is greater than the first determined alignment value by at least a threshold value. The control circuit can replace the commercial object identifier with the replacement commercial object identifier when the opportunity is identified. When each commercial object identifier identified by the purchase opportunity is assessed, the control circuit can cause the communications transceiver to transmit the purchase opportunity to an electronic user device associated with the consumer to thereby be rendered through a consumer user interface implemented on the electronic user device.

In some embodiments, methods are provided for assessing purchase opportunities corresponding to the sale of retail products. Some of these methods include accessing a purchase opportunity having both a consumer identifier that is exclusively associated with a consumer and one or more commercial object identifiers each exclusively associated with a particular commercial object. The consumer identifier is typically associated with one or more first PVs. Each commercial object identifier can be associated one or more second PVs. For each commercial object identifier of the purchase opportunity, the method may include identifying a first alignment value and a second alignment value. By one approach, the first alignment value can correspond to an alignment relationship between the one or more first PVs and the one or more second PVs. The second alignment value can correspond to a relationship between the one or more first PVs and one or more partiality vectors of a replacement commercial object (“third PV”).

In light of the identified alignment values, the method may also identify an opportunity to increase the probability of the consumer participating in the purchase opportunity when the second alignment value is greater than the first determined alignment value by at least a threshold value. The method can replace the commercial object identifier with the replacement commercial object identifier when the opportunity is identified. When each commercial object identifier identified by the purchase opportunity is assessed, the method further may cause transmission of the purchase opportunity to an electronic user device associated with the consumer for rendering through a consumer user interface implemented on the electronic user device.

Generally speaking, pursuant to various embodiments, systems, apparatuses and methods are provided herein useful for determining potential customers for a customizable product. In some embodiments, a system for determining potential customers for a customized product comprises a value vector database, wherein the value vector database includes value vectors of people, and wherein the value vectors indicate partialities of the people and a control circuit, the control circuit configured to determine one or more value propositions associated with a customizable product, determine, from the people, potential customers based on the value vectors associated with the people and the one or more value propositions of the customizable product, and provide an indication of the potential customers.

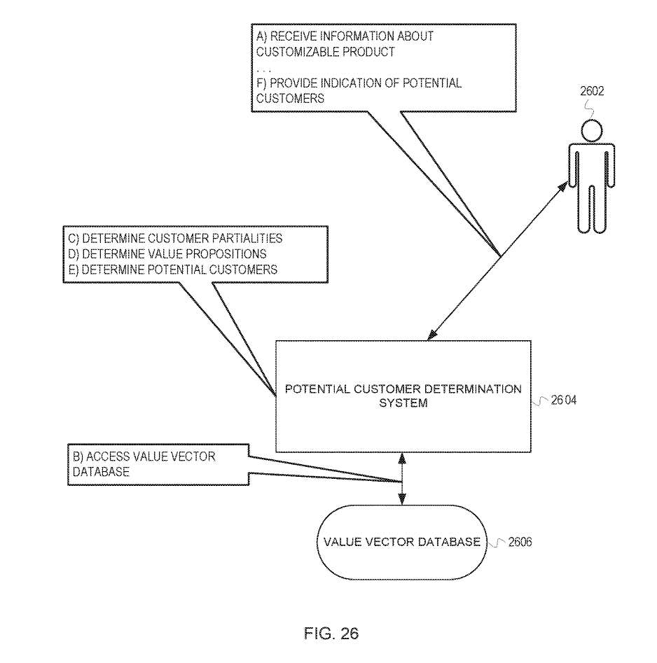

As previously discussed, many retailers and advertisers engage in mass distribution of sales offers and advertising materials to everyone within an area. While such offers and materials may generate some business, it is neither effective nor efficient. Specifically, many people who receive the offers and materials may not be interested or may simply discard the offers and materials without reviewing them thoroughly. These problems can be compounded further for customizable products. Customizable products are products that customers can alter modify, tailor, etc. to their specific tastes. For example, a customer may be able to customize a mug by selecting a color of the mug, a shape of the mug, a material out of which the mug is made, an image/logo/design to be placed on the mug, etc. The problems discussed above can be even more prevalent for customizable products because the offers and materials will not depict the specific item that a person may want (i.e., they depict a generic product, not one customized by the person). Additionally, the offers and materials may include a long list of possible customizations for the product. Customers may find this overwhelming and may not bother to review the list thoroughly. Embodiments of the inventive subject matter seek to eliminate, or at least minimize, these difficulties by identifying potential customers that may be interested in the customizable product. By identifying potential customers, retailers and advertisers can avoid the costs associated with sending offers and materials to people that will not be interested in the customizable product. FIG. 26 provides an overview of such a system.

The discussion of FIG. 26 refers generally to partialities and value propositions. The discussion above and herein provides more detailed information with regard to partialities and value propositions.

FIG. 26 is a diagram depicting example operations for determining potential customers for a customizable product, according to some embodiments. The example operations include operations between a third party 2602 and a potential customer determination system 2604. FIG. 26 depicts operations at stages A-F. These stages are examples and are not necessarily discrete occurrence over time (e.g., the operations of different stages may overlap). Additionally, FIG. 26 is an overview of example operations.

At Stage A, the potential customer determination system 2604 receives information about a customizable product form the third party 2602. In this example, the third party may be a retailer or an advertiser that seeks to market a customizable product. The third party 2602 uses a service which utilizes the potential customer determination system 2604 to determine potential customers for the customizable product. While the discussion of FIG. 26 refers to a third party 2602, embodiments are not so limited. For example, in some embodiments, the entity utilizing the potential customer determination system 2604 to determine potential customers may also own or control the potential customer determination system 2604. Returning to the example, the information about the customizable product can simply include only a name or description of the customizable product. In other embodiments, the information about the customizable product can be more detailed and include information such as dimensions of the customizable product, materials form which the customizable product is made, information regarding how the customizable product is customizable, etc.

At Stage B, the potential customer determination system 2604 accesses a value vector database 2606. The value vector database 2606 includes value vectors for people. The value vectors indicate partialities of the people, as described in more detail herein. In some embodiments, the value vector database 2606, or a separate database, can include additional information about the people such as demographic information, names, addresses, purchase history, etc.

At Stage C, the potential customer determination system 2604 determine customer partialities. The partialities are based on the value vectors retrieved from the value vector database 2606. Partialities and value vectors are described in more detail herein.

At Stage D, the potential customer determination system 2604 determines value propositions associated with the customizable product. The customizable products can present value propositions. Additionally, customization options can also present value propositions. Value propositions are discussed in more detail herein. In some embodiments, the potential customer determination system 2604 receives the value propositions associated with the customizable product from the third party 2602. For example, the third party 2602 can provide the value propositions associated with the customizable product as part of the information about the customizable product. In other embodiments, the potential customer determination system 2604 can take a more active role in determining the value propositions. For example, the potential customer determination system 2604 can determine the value propositions by accessing a database (e.g., the value vector database 2606 or a value proposition database) and searching the database for value propositions associated with characteristics of the customizable product.

At Stage E, the potential customer determination system 2604 determines potential customers for the customizable product. In some embodiments, the potential customer determination system 2604 determines potential customers for the customizable product based on the customer partialities and the value propositions.

At stage F, the potential customer determination system 2604 provides an indication of the potential customers. For example, the potential customer determination system 2604 can provide a list of potential customers to the third party 2602.

While the discussion of FIG. 26 provides a brief overview of a potential customer determination system, the discussion of the previous figures provides more detailed information with respect to value vectors and value propositions.

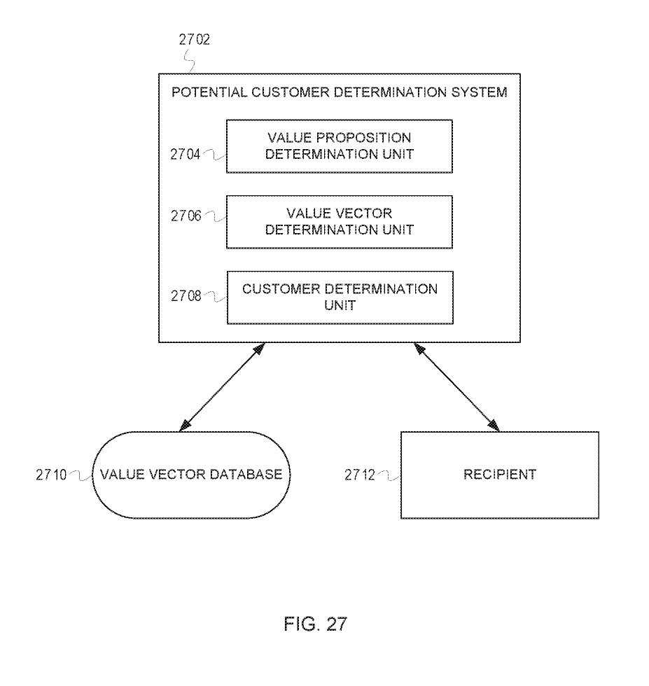

While the discussion above and herein provides additional information about value vectors, partialities, and value propositions, the discussion of FIG. 27 provides additional details about an example potential customer determination system.

FIG. 27 is a block diagram depicting an example potential customer determination system 2702 for determining potential customers for a customizable product, according to some embodiments. The potential customer determination system 2702 includes a value proposition determination unit 2704, a value vector determination unit 2706, and a customer determination unit 2708. The potential customer determination system 2702 is in communication with a value vector database 2710 and a recipient 2712. In some embodiments, the potential customer determination unit 2702 can include the value vector database. Additionally, although FIG. 27 depicts the value proposition determination unit 2704, value vector determination unit 2706, and the customer determination unit 2708 as distinct units, the potential customer determination system 2702 may not include distinct hardware and/or software for each of the units.

The potential customer determination unit 2702 can also include a control circuit (not pictured). The control circuit can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit (e.g., control circuit 1301) is configured (for example, by using corresponding programming as will be well understood by those skilled in the art) to carry out one or more of the steps, actions, and/or functions described herein. By one optional approach the control circuit operably couples to a memory. The memory may be integral to the control circuit or can be physically discrete (in whole or in part) from the control circuit as desired. This memory can also be local with respect to the control circuit 1301 (where, for example, both share a common circuit board, chassis, power supply, and/or housing) or can be partially or wholly remote with respect to the control circuit (where, for example, the memory is physically located in another facility, metropolitan area, or even country as compared to the control circuit). This memory can serve, for example, to non-transitorily store the computer instructions that, when executed by the control circuit, cause the control circuit 1301 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The value proposition determination unit 2704 can determine value propositions for customizable products. In one embodiment, the value proposition database determines value propositions based on information about the customizable product. The potential customer determination system 2702 can receive the information about the customizable product from the recipient 2712. The recipient 2712 can be a third party or any other entity that is utilizing the potential customer determination system 2702 to determine potential customers for a customizable product.

The value vector determination unit 2706 determines value vectors associated with people. In one embodiment, the value vector determination unit 2706 determines the value vectors by accessing the value vector database 2710. In such embodiments, the value vector database 2710 can include information regarding the people as well as value vectors associated with the people. It should be noted that although FIG. 27 depicts the value vector database 2710 as being separate from the potential customer determination system 2702, in some embodiments, the value vector database 2710 is a part of the potential customer determination unit 2702.

The customer determination unit 2708 determines the potential customers based on the value propositions and the value vectors. For example, the customer determination unit 2708 can find matches between the value propositions and the value vectors. In a more complex embodiment, the customer determination unit 2708 can consider not only value propositions provided by the customizable product, but also value propositions associated with specific customization possibilities. In such embodiments, the customer determination unit 2708 can determine not only customers that might be interested in the customizable product, but also in what customizations the potential customers might be interested. The customer determination unit 2708 can compile this information and provide an indication of this information, for example, the recipient 2712. The indication of the potential customers can be a list, array, or any other suitable datatype for providing the indication of the potential customers.

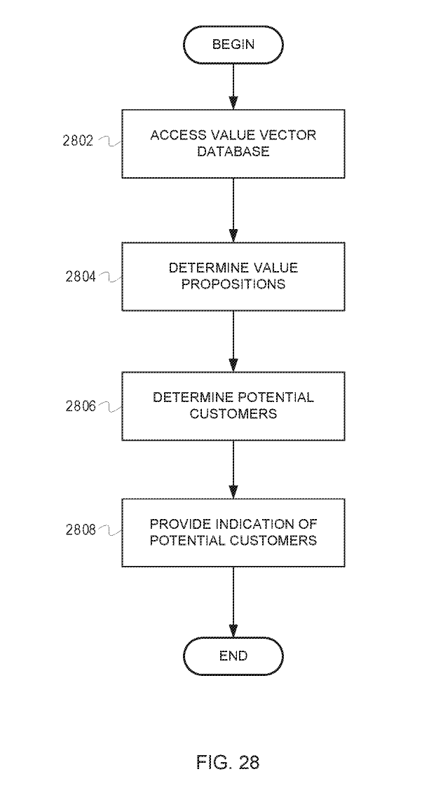

While the discussion of FIG. 27 provides additional details regarding an example potential customer determination system, the discussion of FIG. 28 describes example operations performed by a potential customer determination system.

FIG. 28 is a flow chart depicting example operations for determining potential customers for a customizable product, according to some embodiments. The flow beings at block 2802.

At block 2802, a value vector database is accessed. For example, a potential customer determination system can access a value vector database. The value vector database can include people and value vectors associated with the people. In some embodiments, the potential customer determination unit can target specific areas, such as geographic areas. In such embodiments, the potential customer determination system determines value vectors associated with people within the area. The flow continues at block 2804.

At block 2804, value propositions are determined. For example, the potential customer determination system can determine value propositions associated with a customizable product. The value propositions can be related to the customizable product itself, possible customizations for the customizable product, or both. The flow continues at block 2806.

At block 2806, potential customers are determined. For example, the potential customer determination system can determine the potential customers. The potential customer determination unit can determine the potential customers based on the value propositions and the value vectors. For example, the potential customer determination system can determine potential customers by finding matches between the value vectors and the value propositions. In some embodiments, the potential customer determination unit can also determine customizations that some or all of the potential customers may like. The flow continues at block 2808.

At block 2808, an indication of the potential customers is provided. For example, the potential customer determination system can provide the indication of the potential customers. The indication of the potential customers can take the form of a list, array, etc.

In some embodiments, a system for determining potential customers for a customized product comprises a value vector database, wherein the value vector database includes value vectors of people, and wherein the value vectors indicate partialities of the people and a control circuit, the control circuit configured to determine one or more value propositions associated with a customizable product, determine, from the people, potential customers based on the value vectors associated with the people and the one or more value propositions of the customizable product, and provide an indication of the potential customers.

In some embodiments, a method for determining potential customers for a customized product comprises accessing a value vector database, wherein the value vector database includes value vectors associated with people, and wherein the value vectors indicate partialities of the people, determining one or more value propositions associated with a customizable product, determining, from the people, the potential customers based on the value vectors associated with the people and the one or more value propositions of the customizable product, and providing an indication of the potential customers.

The following describes and summaries various embodiments as described variously throughout this specification. In some embodiments, an apparatus comprises: memory having stored therein: information including a plurality of partiality vectors for a customer; and vectorized characterizations for each of a plurality of products, wherein each of the vectorized characterizations indicates a measure regarding an extent to which a corresponding one of the products accords with a corresponding one of the plurality of partiality vectors; and a control circuit operably coupled to the memory and configured as a state engine that uses the partiality vectors and the vectorized characterizations to identify at least one product to present to the customer.

Further implementations of these embodiments are provided. For example, in some implementations, the control circuit is configured as a state engine that uses the partiality vectors and the vectorized characterizations to identify at least one product to present to the customer by using the partiality vectors and the vectorized characterizations to identify at least one product to assist the customer with realizing an aspiration of the customer. In some implementations, the control circuit is configured as a state engine that uses the partiality vectors and the vectorized characterizations to identify at least one product to present to the customer by using the partiality vectors and the vectorized characterizations to identify at least one product to assist the customer with restoring the customer's order consistent with their partiality vectors. In some implementations, the state engine is configured to have: a first state to process the partiality vectors and the vectorized characterizations to identify a product to at least maintain or to reduce the customer's effort; and a second, different state to process the partiality vectors and the vectorized characterizations to identify at least one product to assist the customer with realizing an aspiration of the customer. In some implementations, the state engine is further configured to have a customer baseline experience state. In some implementations, the state engine is further configured to have a disorder disambiguation state and wherein the state engine transitions from the customer baseline experience state to the disorder disambiguation state in response to detecting disorder with respect to the customer's baseline experience. In some implementations, the disorder disambiguation state serves to determine when the detected disorder comprises a disruption occasioned by the customer when reordering their life towards realizing an aspiration, in which case the disorder disambiguation state transitions to the second state. In some implementations, the disorder disambiguation state also serves to determine when the detected disorder is not a disruption occasioned by the customer when reordering their life towards realizing an aspiration, in which case the disorder disambiguation state transitions to the first state.

In some embodiments, a method by a control circuit comprises: using a plurality of partiality vectors for a customer and vectorized characterizations for each of a plurality of products, wherein each of the vectorized characterizations indicates a measure regarding an extent to which a corresponding one of the products accords with a corresponding one of the plurality of partiality vectors within a state engine to identify at least one product to present to the customer.

Further implementations of these embodiments are provided. For example, in some implementations, using the partiality vectors and the vectorized characterizations to identify at least one product to present to the customer comprises using the partiality vectors and the vectorized characterizations to identify at least one product to assist the customer with realizing an aspiration of the customer. In some implementations, using the partiality vectors and the vectorized characterizations to identify at least one product to present to the customer comprises using the partiality vectors and the vectorized characterizations to identify at least one product to assist the customer with restoring the customer's order consistent with their partiality vectors. In some implementations, using a plurality of partiality vectors for a customer and vectorized characterizations for each of a plurality of products, wherein each of the vectorized characterizations indicates a measure regarding an extent to which a corresponding one of the products accords with a corresponding one of the plurality of partiality vectors within a state engine comprises using: a first state to process the partiality vectors and the vectorized characterizations to identify a product to at least maintain or to reduce the customer's effort; and a second, different state to process the partiality vectors and the vectorized characterizations to identify at least one product to assist the customer with realizing an aspiration of the customer. In some implementations, using a plurality of partiality vectors for a customer and vectorized characterizations for each of a plurality of products, wherein each of the vectorized characterizations indicates a measure regarding an extent to which a corresponding one of the products accords with a corresponding one of the plurality of partiality vectors within a state engine comprises using: a customer baseline experience state. In some implementations, using a plurality of partiality vectors for a customer and vectorized characterizations for each of a plurality of products, wherein each of the vectorized characterizations indicates a measure regarding an extent to which a corresponding one of the products accords with a corresponding one of the plurality of partiality vectors within a state engine comprises using: a disorder disambiguation state wherein the state engine transitions from the customer baseline experience state to the disorder disambiguation state in response to detecting disorder with respect to the customer's baseline experience. In some implementations, the disorder disambiguation state serves to determine when the detected disorder comprises a disruption occasioned by the customer when reordering their life towards realizing an aspiration, in which case the disorder disambiguation state transitions to the second state. In some implementations, the disorder disambiguation state also serves to determine when the detected disorder is not a disruption occasioned by the customer when reordering their life towards realizing an aspiration, in which case the disorder disambiguation state transitions to the first state.

In some embodiments, an apparatus comprises: memory having stored therein: information including a plurality of partiality vectors for a customer; and vectorized characterizations for each of a plurality of products, wherein each of the vectorized characterizations indicates a measure regarding an extent to which a corresponding one of the products accords with a corresponding one of the plurality of partiality vectors; and a control circuit operably coupled to the memory and configured to select a particular one of the plurality of products to present to the customer as a function, at least in part, of the partiality vectors, wherein when a plurality of the products are equally suitable in view of the partiality vectors, the control circuit selects a particular one of the equally suitable products to present to the customer as a function, at least in part, of whichever of the equally suitable products offers a highest degree of freedom of usage.

Further implementations of these embodiments are provided. For example, in some implementations, selecting the particular one of the plurality of products to present to the customer comprises selecting the particular one of the plurality of products to offer to the customer for purchase. In some implementations, selecting the particular one of the plurality of products to present to the customer comprises selecting the particular one of the plurality of products to delivery to the customer without cost to the customer. In some implementations, selecting the particular one of the plurality of products to present to the customer comprises selecting the particular one of the plurality of products to ship to the customer without the customer having ordered the particular one of the plurality of products. In some implementations, each degree of freedom of usage corresponds to a different modality of usage. In some implementations, the memory has stored therein information regarding the degree of freedom of usage for at least some of the plurality of products. In some implementations, the memory has stored therein information regarding the degree of freedom of usage for at least a majority of the plurality of products. In some implementations, the control circuit is further configured to determine on an as-needed basis the degree of freedom of usage for particular ones of the plurality of products. In some implementations, the control circuit is further configured to: facilitate presenting to the customer the particular one of the plurality of products in conjunction with information explaining the degree of freedom of usage that corresponds to the particular one of the plurality of products. In some implementations, the control circuit is configured to select a particular one of the equally suitable products to present to the customer as a function, at least in part, of whichever of the equally suitable products offers a highest degree of freedom of usage wherein considered degrees of freedom of usage include at least one of: a future value proposition; and a past value proposition. In some implementations, the control circuit is further configured to select a particular one of the plurality of products to present to the customer as a function, at least in part, of objective information regarding at least one of the customer and objective logistical information regarding providing particular products to the customer. In some implementations, the objective information comprises at least one of information regarding: location information; budget information; age information; gender information; product availability; shipping limitations; applicable legal limitations.

In some embodiments, a method by a control circuit comprises: selecting a particular one of a plurality of products to present to a customer as a function, at least in part, of information including a plurality of partiality vectors for the customer and vectorized characterizations for each of the plurality of products, wherein each of the vectorized characterizations indicates a measure regarding an extent to which a corresponding one of the products accords with a corresponding one of the plurality of partiality vectors, wherein when a plurality of the products are equally suitable in view of the partiality vectors, selecting a particular one of the equally suitable products to present to the customer as a function, at least in part, of whichever of the equally suitable products offers a highest degree of freedom of usage.

Further implementations of these embodiments are provided. For example, in some implementations, selecting the particular one of the plurality of products to present to the customer comprises selecting the particular one of the plurality of products to offer to the customer for purchase. In some embodiments, selecting the particular one of the plurality of products to present to the customer comprises selecting the particular one of the plurality of products to delivery to the customer without cost to the customer. In some embodiments, selecting the particular one of the plurality of products to present to the customer comprises selecting the particular one of the plurality of products to ship to the customer without the customer having ordered the particular one of the plurality of products. In some embodiments, each degree of freedom of usage corresponds to a different modality of usage. In some embodiments, the method further comprises: accessing information regarding the degree of freedom of usage for at least some of the plurality of products. In some embodiments, the method further comprises accessing information regarding the degree of freedom of usage for at least a majority of the plurality of products. In some embodiments, the method further comprises determining on an as-needed basis the degree of freedom of usage for particular ones of the plurality of products. In some embodiments, the method further comprises facilitating presenting to the customer the particular one of the plurality of products in conjunction with information explaining the degree of freedom of usage that corresponds to the particular one of the plurality of products.

In some embodiments, an apparatus comprises: memory having stored therein: information including a plurality of partiality vectors for a customer; and vectorized characterizations for each of a plurality of products, wherein each of the vectorized characterizations indicates a measure regarding an extent to which a corresponding one of the products accords with a corresponding one of the plurality of partiality vectors; a control circuit operably coupled to the memory and configured to: use the partiality vectors and the vectorized characterizations to identify at least one product to present to the customer by, at least in part: using the partiality vectors and the vectorized characterizations to define a plurality of solutions that collectively form a multi-dimensional surface; and selecting the at least one product from the multi-dimensional surface.

Further implementations of these embodiments are provided. For example, in some implementations, the control circuit is further configured to use the partiality vectors and the vectorized characterizations to identify at least one product to present to the customer by, at least in part: accessing other information for the customer comprising information other than partiality vectors; using the other information to constrain a selection area on the multi-dimensional surface from which the at least one product can be selected. In some implementations, the other information comprises objective information. In some implementations, the objective information comprises objective information regarding the customer. In some implementations, the objective information comprises information regarding at least one of: location information; budget information; age information; gender information. In some implementations, the objective information comprises objective logistical information regarding providing particular products to the customer. In some implementations, the objective logistical information regarding providing particular products to the customer comprises information regarding at least one of: product availability; shipping limitations; applicable legal limitations. In some implementations, the control circuit is configured to use the objective information to constrain the selection area on the multi-dimensional surface from which the at least one product can be selected by, at least in part, using the objective information to form at least one objective-information vector that identifies the selection area. In some implementations, the selection area represents an approximately 95% solution space. In some implementations, the control circuit is configured to use the partiality vectors in combination with the at least one objective-information vector to identify the at least one product from the selection area. In some implementations, the control circuit is configured to select the at least one product from the multi-dimensional surface by, at least in part, identifying a particular product that requires a minimal expenditure of customer effort. In some implementations, the control circuit is configured to identify the particular product that requires a minimal expenditure of customer effort while also remaining compliant with at least one objective constraint. In some implementations, the at least one objective constraint comprises at least one of objective information regarding the customer and objective logistical information regarding providing particular products to the customer.

In some embodiments, a method by a control circuit comprises: using information including a plurality of partiality vectors for a customer and vectorized characterizations for each of a plurality of products, wherein each of the vectorized characterizations indicates a measure regarding an extent to which a corresponding one of the products accords with a corresponding one of the plurality of partiality vectors, to identify at least one product to present to the customer by, at least in part: using the partiality vectors and the vectorized characterizations to define a plurality of solutions that collectively form a multi-dimensional surface; selecting the at least one product from the multi-dimensional surface.

Further implementations of these embodiments are provided. For example, in some implementations, the method further comprises using the partiality vectors and the vectorized characterizations to identify at least one product to present to the customer by, at least in part: accessing other information for the customer comprising information other than partiality vectors; using the other information to constrain a selection area on the multi-dimensional surface from which the at least one product can be selected. In some implementations, the other information comprises objective information. In some implementations, the objective information comprises objective information regarding the customer. In some implementations, the objective information comprises information regarding at least one of: location information; budget information; age information; gender information. In some implementations, the objective information comprises objective logistical information regarding providing particular products to the customer. In some implementations, the objective logistical information regarding providing particular products to the customer comprises information regarding at least one of: product availability; shipping limitations; applicable legal limitations. In some implementations, selecting the at least one product from the multi-dimensional surface comprises, at least in part, identifying a particular product that requires a minimal expenditure of customer effort. In some implementations, identifying the particular product that requires a minimal expenditure of customer effort comprises identifying the particular product that requires a minimal expenditure of customer effort while also remaining compliant with at least one objective constraint. In some implementations, the at least one objective constraint comprises at least one of objective information regarding the customer and objective logistical information regarding providing particular products to the customer.

In some embodiments, an apparatus comprises: memory having stored therein: information including a plurality of partiality vectors for a customer; and vectorized characterizations for each of a plurality of products, wherein each of the vectorized characterizations indicates a measure regarding an extent to which a corresponding one of the products accords with a corresponding one of the plurality of partiality vectors; a control circuit operably coupled to the memory and configured to: identify an aspiration of the customer; use the partiality vectors and the vectorized characterizations to identify at least one product to assist the customer with realizing the aspiration.

Further implementations of these embodiments are provided. For example, in some implementations, the memory further has stored therein information regarding a routine experiential base state for the customer and wherein the control circuit is further configured to: detect a disruption to the routine experiential base state for the customer. In some implementations, the control circuit is configured to identify an aspiration of the customer by, at least in part, determining whether the disruption to the routine experiential base state for the customer is a disruption occasioned by the customer reordering their life towards realizing the aspiration. In some implementations, the control circuit is configured to identify the aspiration of the customer by disambiguating amongst a plurality of candidate aspirations that are consistent with the disruption to the routine experiential base state for the customer. In some implementations, upon determining that the disruption is not occasioned by the customer reordering their life towards realizing the aspiration, the control circuit is further configured to use the partiality vectors and the vectorized characterizations to identify at least one product to assist the customer with restoring the customer's order consistent with their partiality vectors. In some implementations, the control circuit is also configured to use expert inputs when identifying the at least one product to assist the customer with realizing the aspiration. In some implementations, the control circuit is configured to use the partiality vectors and the vectorized characterizations to identify the least one product to assist the customer with realizing the aspiration by, at least in part: identifying a plurality of incremental steps that correspond to realizing the aspiration; for a selected one of the plurality of incremental steps, use the partiality vectors and the vectorized characterizations to identify at least one product to assist the customer with accomplishing the selected one of the plurality of incremental steps. In some implementations, the control circuit is further configured to: determine the customer's present state of accomplishment as regards the plurality of incremental steps to thereby identify the selected one of the plurality of incremental steps. In some implementations, the control circuit is further configured to identify the aspiration of the customer by, at least in part, determining an extent of the customer's aspiration. In some implementations, the control circuit is configured to use the partiality vectors and the vectorized characterizations to identify at least one product to assist the customer with realizing the aspiration by identifying at least one product that is consistent with the determined extent of the customer's aspiration. In some implementations, the control circuit is further configured to: select at least one product to provide without cost to the customer to test the extent of the customer's aspiration.

In some embodiments, a method by a control circuit comprises: identifying an aspiration of a customer; using partiality vectors for the customer and vectorized characterizations for each of a plurality of products, wherein each of the vectorized characterizations indicates a measure regarding an extent to which a corresponding one of the products accords with a corresponding one of the plurality of partiality vectors to identify at least one product to assist the customer with realizing the aspiration.

Further implementations of these embodiments are provided. For example, in some implementations, the method further comprises: detecting a disruption to a routine experiential base state for the customer. In some implementations, the method further comprises: determining whether the disruption to the routine experiential base state for the customer is a disruption occasioned by the customer reordering their life towards realizing the aspiration. In some implementations, the method further comprises: upon determining that the disruption is not occasioned by the customer reordering their life towards realizing the aspiration, using the partiality vectors and the vectorized characterizations to identify at least one product to assist the customer with restoring the customer's order consistent with their partiality vectors. In some implementations, identifying at least one product to assist the customer with realizing the aspiration further comprises using expert inputs when identifying the at least one product to assist the customer with realizing the aspiration. In some implementations, using the partiality vectors and the vectorized characterizations to identify the least one product to assist the customer with realizing the aspiration further comprises, at least in part: identifying a plurality of incremental steps that correspond to realizing the aspiration; for a selected one of the plurality of incremental steps, using the partiality vectors and the vectorized characterizations to identify at least one product to assist the customer with accomplishing the selected one of the plurality of incremental steps. In some implementations, the method further comprises: determining the customer's present state of accomplishment as regards the plurality of incremental steps to thereby identify the selected one of the plurality of incremental steps. In some implementations, identifying the aspiration of the customer further comprises, at least in part, determining an extent of the customer's aspiration. In some implementations, using the partiality vectors and the vectorized characterizations to identify at least one product to assist the customer with realizing the aspiration further comprises identifying at least one product that is consistent with the determined extent of the customer's aspiration.

In some embodiments, a system for determining potential customers for a customized product, the system comprises: a value vector database, wherein the value vector database includes value vectors of people, and wherein the value vectors indicate partialities of the people; and a control circuit configured to: determine one or more value propositions associated with a customizable product; determine, from the people, the potential customers based on the value vectors associated with the people and the one or more value propositions of the customizable product; and provide an indication of the potential customers.

Further implementations of these embodiments are provided. For example, in some implementations, the operation to determine the potential customers is based on similarities between the value vectors associated with the people and the one or more value propositions associated with the customizable product. In some implementations, the control circuit is further configured to: receive an indication of the customizable product, wherein the indication of the customizable product includes an indication of the one or more value propositions associated with the customizable product. In some implementations, the indication of the customizable product is received from a third party. In some implementations, the indication of the customizable product includes information regarding how the customizable product is customizable. In some implementations, the control circuit is further configured to: determine, based on the value vectors associated with the people and the information regarding how the customizable product is customizable, customizations for one or more of the potential customers. In some implementations, the operation to provide the indication of the potential customers includes providing the indication of the potential customers to a third party. In some implementations, the control circuit is further configured to: determine an area, wherein the operation to determine the potential customers is based on the area. In some implementations, the area is a geographic area.

In some embodiments, a method for determining potential customers for a customized product, the method comprises: accessing a value vector database, wherein the value vector database includes value vectors of people, and wherein the value vectors indicate partialities of the people; determining one or more value propositions associated with a customizable product; determining, from the people, the potential customers based on the value vectors associated with the people and the one or more value propositions of the customizable product; and providing an indication of the potential customers.

Further implementations of these embodiments are provided. For example, in some implementations, determining the potential customers is based on similarities between the value vectors associated with the people and the one or more value propositions associated with the customizable product. In some implementations, the method further comprises: receiving an indication of the customizable product, wherein the indication of the customizable product includes an indication of the one or more value propositions associated with the customizable product. In some implementations, the indication of the customizable product is received from a third party. In some implementations, the indication of the customizable product includes information regarding how the customizable product is customizable. In some implementations, the method further comprises determining, based on the value vectors associated with the people and the information regarding how the customizable product is customizable, customizations for one or more of the potential customers. In some implementations, providing the indication of the potential customers includes providing the indication of the potential customers to a third party. In some implementations, the method further comprises: determining an area, wherein the determining the potential customers is based on the area. In some implementations, the area is a geographic area.

This application is related to, and incorporates herein by reference in its entirety, each of the following U.S. provisional applications listed as follows by application number and filing date: 62/323,026 filed Apr. 15, 2016; 62/341,993 filed May 26, 2016; 62/348,444 filed Jun. 10, 2016; 62/350,312 filed Jun. 15, 2016; 62/350,315 filed Jun. 15, 2016; 62/351,467 filed Jun. 17, 2016; 62/351,463 filed Jun. 17, 2016; 62/352,858 filed Jun. 21, 2016; 62/356,387 filed Jun. 29, 2016; 62/356,374 filed Jun. 29, 2016; 62/356,439 filed Jun. 29, 2016; 62/356,375 filed Jun. 29, 2016; 62/358,287 filed Jul. 5, 2016; 62/360,356 filed Jul. 9, 2016; 62/360,629 filed Jul. 11, 2016; 62/365,047 filed Jul. 21, 2016; 62/367,299 filed Jul. 27, 2016; 62/370,853 filed Aug. 4, 2016; 62/370,848 filed Aug. 4, 2016; 62/377,298 filed Aug. 19, 2016; 62/377,113 filed Aug. 19, 2016; 62/380,036 filed Aug. 26, 2016; 62/381,793 filed Aug. 31, 2016; 62/395,053 filed Sep. 15, 2016; 62/397,455 filed Sep. 21, 2016; 62/400,302 filed Sep. 27, 2016; 62/402,068 filed Sep. 30, 2016; 62/402,164 filed Sep. 30, 2016; 62/402,195 filed Sep. 30, 2016; 62/402,651 filed Sep. 30, 2016; 62/402,692 filed Sep. 30, 2016; 62/402,711 filed Sep. 30, 2016; 62/406,487 filed Oct. 11, 2016; 62/408,736 filed Oct. 15, 2016; 62/409,008 filed Oct. 17, 2016; 62/410,155 filed Oct. 19, 2016; 62/413,312 filed Oct. 26, 2016; 62/413,304 filed Oct. 26, 2016; 62/413,487 filed Oct. 27, 2016; 62/422,837 filed Nov. 16, 2016; 62/423,906 filed Nov. 18, 2016; 62/424,661 filed Nov. 21, 2016; 62/427,478 filed Nov. 29, 2016; 62/436,842 filed Dec. 20, 2016; 62/436,885 filed Dec. 20, 2016; 62/436,791 filed Dec. 20, 2016; 62/439,526 filed Dec. 28, 2016; 62/442,631 filed Jan. 5, 2017; 62/445,552 filed Jan. 12, 2017; 62/463,103 filed Feb. 24, 2017; 62/465,932 filed Mar. 2, 2017; 62/467,546 filed Mar. 6, 2017; 62/467,968 filed Mar. 7, 2017; 62/467,999 filed Mar. 7, 2017; 62/471,804 filed Mar. 15, 2017; 62/471,830 filed Mar. 15, 2017; 62/479,525 filed Mar. 31, 2017; 62/480,733 filed Apr. 3, 2017; 62/482,863 filed Apr. 7, 2017; 62/482,855 filed Apr. 7, 2017; and 62/485,045 filed Apr. 13, 2017.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A system to assess purchase opportunities corresponding to the sale of retail products, comprising:
a database comprising a plurality of partiality vectors (“PV”) each associated with one of: a commercial object and a consumer;
a communication transceiver; and
a control circuit communicatively coupled to the transceiver and the database and configured to:
access a purchase opportunity comprising information regarding a consumer identifier exclusively associated with a consumer and a first commercial object identifier exclusively associated with a first commercial object, wherein the consumer identifier and the first commercial object identifier are associated with a first PV and a second PV, respectively;
ascertain a first alignment value and a second alignment value, wherein the first alignment value corresponds to an alignment relationship between the first PV and the second PV, the second alignment value corresponds to an alignment relationship between the first PV and a third PV, the third PV is associated with a second commercial object, and the second commercial object shares a threshold amount of characteristics with the first commercial object;
identify an opportunity to increase a probability of the consumer participating in the purchase opportunity when the second alignment value is greater than the first determined alignment value by at least a threshold value;
replace the first commercial object in the purchase opportunity with the second commercial object when the opportunity is identified; and
cause the communication transceiver to transmit the purchase opportunity to an electronic user device associated with the consumer to be rendered through a consumer user interface implemented on the electronic user device.

2. The system of claim 1, wherein
in ascertaining the first alignment value the control circuit is further configured to ascertain a first scalar value that corresponds to a dot product of the first PV and the second PV; and
in ascertaining the second alignment value the control circuit is further configured to ascertain a second scalar value that corresponds to a dot product of the first PV and the third PV.

3. The system of claim 2, wherein
in ascertaining the first alignment value the control circuit is further configured to ascertain an average of two or more first scalar values; and
in ascertaining the second alignment value the control circuit is further configured to ascertain an average of two or more second scalar values.

4. The system of claim 2, wherein
in ascertaining the first alignment value the control circuit is further configured to ascertain a sum of two or more first scalar values; and
in ascertaining the second alignment value the control circuit is further configured to ascertain a sum of two or more second scalar values.

5. The system of claim 1, wherein the control circuit is configured to ascertain the second alignment value when the ascertained first alignment value comprises a value below a threshold amount.

6. The system of claim 1, wherein the plurality PVs each comprise at least one of: a value-basis, an affinity-basis, an aspiration-basis, and preference-basis.

7. The system of claim 1, wherein the first commercial object and the second commercial object each comprise a characteristic associated with at least one of: freshness, sourcing, a material type, production type, and ecological impact.

8. The system of claim 1, wherein
the purchase opportunity is associated with a non-retail event;
the consumer comprises a first plurality of persons associated with the non-retail event; and
the first PV comprises a value at least partially generated using data associated with a second plurality of persons that are representative of the first plurality of persons.

9. The system of claim 1, wherein the control circuit is further configured to recalculate the first PV when consumer-related data is received in the database, and wherein the consumer-related data comprises one or more of: a value, a preference, an aspiration, and an affinity.

10. A method of assessing purchase opportunities corresponding to the sale of retail products, comprising:
accessing, by a control circuit, a purchase opportunity comprising information regarding a consumer identifier exclusively associated with a consumer and a first commercial object identifier exclusively associated with a first commercial object, each associated with a first partiality vector (“PV”) and a second PV, respectively;
ascertain, by the control circuit, a first alignment value and a second alignment value, the first alignment value corresponds to an alignment relationship between the first PV and the second PV, the second alignment value corresponds to an alignment relationship between the first PV and a third PV, the third PV is associated with a second commercial object, and the second commercial object shares a threshold amount of characteristics with the first commercial object;
identifying, by the control circuit, an opportunity to increase a probability of the consumer participating in the purchase opportunity when the second alignment value is greater than the first determined alignment value by at least a threshold value; and
replacing, by the control circuit, the first commercial object in the purchase opportunity with the second commercial object when the opportunity is identified; and
transmitting, by a transceiver communicatively coupled to the control circuit, the purchase opportunity to an electronic user device associated with the consumer to be rendered through a consumer user interface implemented on the electronic user device.

11. The method of claim 10, wherein
the step of ascertaining the first alignment value comprises ascertaining a first scalar value that corresponds to a dot product of the first PV and the second PV; and
the step of ascertaining the second alignment value comprises ascertaining a second scalar value that corresponds to a dot product of the first PV and the third PV.

12. The method of claim 11, wherein
the step of ascertaining the first alignment value comprises ascertaining an average of two or more first scalar values; and
the step of ascertaining the second alignment value comprises ascertaining an average of two or more second scalar values.

13. The method of claim 11, wherein:
the step of ascertaining the first alignment value comprises ascertaining a sum of two or more first scalar values; and
the step of ascertaining the second alignment value comprises ascertaining a sum of two or more second scalar values.

14. The method of claim 10, wherein the second alignment value is ascertained when the first alignment value is below a threshold amount.

15. The method of claim 10, wherein the first PV, second PV, and third PV each comprise at least one of: a value-basis, an affinity-basis, an aspiration-basis, and preference-basis.

16. The method of claim 10, wherein the first commercial object and the second commercial object each comprises a characteristic associated with at least one of: freshness, sourcing, a material type, production type, and ecological impact.

17. The method of claim 10, wherein
the purchase opportunity is associated with a non-retail event;
the consumer comprises a first plurality of persons associated with the non-retail event; and
the first PV comprises a value at least partially generated using data associated with a second plurality of persons that are representative of the first plurality of persons.

18. The method of claim 10, further comprising recalculating the first PV when consumer-related data is received, and wherein the consumer-related data comprises one or more of: a value, a preference, an aspiration, and an affinity.
